(19) United States
(12) Patent Application Publication
(10) Pub. No.: US 2024/0298302 A1
(43) Pub. Date: Sep. 5, 2024

(54) SMALL DATA TRANSFER TECHNIQUES FOR NON-TERRESTIAL NETWORKS

(71) Applicant: QUALCOMM INCORPORATED, San Diego, CA (US)

(72) Inventors: Ruiming ZHENG, Beijing (CN); Chao WEI, Beijing (CN); Qiaoyu LI, Beijing (CN); Hao XU, Beijing (CN)

(21) Appl. No.: 18/550,937

(22) PCT Filed: Jun. 4, 2021
(86) PCT No.: PCT/CN2021/098276

§ 371 Date: Sep. 15, 2023

(51) Int. Cl. H04W 72/0446; H04W 74/0833

(52) U.S. Cl. CPC H04W 72/0446; H04W 74/0833

(57) ABSTRACT

Certain aspects of the present disclosure provide techniques for communicating user data in a small data transfer (SDT) in a non-terrestrial network (NTN) while a user equipment (UE) is in an idle or inactive mode. A method that may be performed the UE includes transmitting, to a non-terrestrial base station (NTBS) in an NTN, an SDT indication message including a first indication that the UE has user data to transmit in an SDT while the UE is in an idle or inactive mode, receiving, from the NTBS in response to the SDT indication message, a resource indication message including an indication of a set of resources for transmitting user data in the SDT, and transmitting the user data in the SDT to the NTBS while the UE is in the idle or inactive mode via the set of resources indicated in the resource indication message.

### INTRODUCTION

Aspects of the present disclosure relate to wireless communications, and more particularly, to techniques for small data transfer (SDT) in non-terrestrial networks (NTN).

Wireless communication systems are widely deployed to provide various telecommunication services such as telephony, video, data, messaging, broadcasts, or other similar types of services. These wireless communication systems may employ multiple-access technologies capable of supporting communication with multiple users by sharing available system resources with those users (e.g., bandwidth, transmit power, or other resources). Multiple-access technologies can rely on any of code division, time division, frequency division orthogonal frequency division, single-carrier frequency division, or time division synchronous code division, to name a few. These and other multiple access technologies have been adopted in various telecommunication standards to provide a common protocol that enables different wireless devices to communicate on a municipal, national, regional, and even global level.

Although wireless communication systems have made great technological advancements over many years, challenges still exist. For example, complex and dynamic environments can still attenuate or block signals between wireless transmitters and wireless receivers, undermining various established wireless channel measuring and reporting mechanisms, which are used to manage and optimize the use of finite wireless channel resources. Consequently, there exists a need for further improvements in wireless communications systems to overcome various challenges.

### SUMMARY

Certain aspects can be implemented in a method for wireless communication performed by a user equipment (UE). The method generally includes transmitting, to a non-terrestrial base station (NTBS) in a non-terrestrial network (NTN), a small data transfer (SDT) indication message including a first indication that the UE has user data to transmit in an SDT while the UE is in an idle or inactive mode, receiving, from the NTBS in response to the SDT indication message, a resource indication message including an indication of a set of resources for transmitting the user data in the SDT while the UE is in the idle or inactive mode, and transmitting the user data in the SDT to the NTBS while the UE is in the idle or inactive mode via the set of resources indicated in the resource indication message.

Certain aspects can be implemented in a method for wireless communication performed by a user equipment (UE). The method generally includes receiving, from a first non-terrestrial base station (NTBS) in a non-terrestrial network (NTN), a first message including: a first indication of a set of resources for communicating user data in a small data transfer (SDT) while the UE is in an idle or inactive mode and a second indication of a dedicated random access channel (RACH) preamble for initiating the SDT. The method also includes communicating the user data in the SDT while the UE is in the idle or inactive mode via the set of resources indicated in the first message.

Certain aspects can be implemented in a method for wireless communication performed by a non-terrestrial base station (NTBS). The method generally includes receiving, from a user equipment (UE) in a non-terrestrial network (NTN), a small data transfer (SDT) indication message including a first indication that the UE has user data to transmit in an SDT while the UE is in an idle or inactive mode, transmitting, to the UE in response to the SDT indication message, a resource indication message including an indication of a set of resources for transmitting the user data in the SDT while the UE is in the idle or inactive mode, and receiving the user data in the SDT from the UE while the UE is in the idle or inactive mode via the set of resources indicated in the resource indication message.

Certain aspects can be implemented in a method for wireless communication performed by a non-terrestrial base station (NTBS). The method generally includes transmitting, to a user equipment (UE) in a non-terrestrial network (NTN), a first message including: a first indication of a set of resources for communicating user data in a small data transfer (SDT) while the UE is in an idle or inactive mode and a second indication of a dedicated random access channel (RACH) preamble for initiating the SDT.

Other aspects provide: an apparatus operable, configured, or otherwise adapted to perform the aforementioned methods as well as those described elsewhere herein; a non-transitory, computer-readable media comprising instructions that, when executed by one or more processors of an apparatus, cause the apparatus to perform the aforementioned methods as well as those described elsewhere herein; a computer program product embodied on a computer-readable storage medium comprising code for performing the aforementioned methods as well as those described elsewhere herein; and an apparatus comprising means for performing the aforementioned methods as well as those described elsewhere herein. By way of example, an apparatus may comprise a processing system, a device with a processing system, or processing systems cooperating over one or more networks.

The following description and the appended figures set forth certain features for purposes of illustration.

### BRIEF DESCRIPTION OF THE DRAWINGS

The appended figures depict certain features of the various aspects described herein and are not to be considered limiting of the scope of this disclosure.

FIG. 1 is a block diagram conceptually illustrating an example wireless communication network.

FIG. 2 is a block diagram conceptually illustrating aspects of an example a wireless communication device and user equipment.

FIGS. 3A-3D depict various example aspects of data structures for a wireless communication network.

FIG. 4 illustrates an example non-terrestrial network.

FIGS. 5A and 5B illustrate different non-terrestrial network architectures.

FIGS. 6-9 are a call flow diagram illustrating example operations for communicating user data in a small data transfer between a non-terrestrial base station and a user equipment in a non-terrestrial network.

FIGS. 10-13 illustrate example process flows for communicating user data in a small data transfer in a non-terrestrial network.

FIGS. 14 and 15 depicts aspects of example communications devices.

### DETAILED DESCRIPTION

Aspects of the present disclosure provide apparatuses, methods, processing systems, and computer-readable mediums for communicating user data in a small data transfer (SDT) in a non-terrestrial network (NTN) by a user equipment (UE) in an idle or inactive mode.

For example, when actively communicating with a base station, such as a non-terrestrial base station (NTBS), a UE may operate in a connected mode. However, in some cases, to conserve power when not communicating with the NTBS, the UE may transition to an idle or inactive mode. While in the idle or inactive mode, data transmission may be restricted. As such, the UE has to resume a connection with the NTBS (e.g., transition to the connected mode) to receive any downlink (DL) data or transmit any uplink (UL) data, regardless of the amount of data for transfer. In other words, regardless of the amount of data or how infrequent the data transfer is, the UE must perform a connection setup procedure and be subsequently released to the inactive state for each data transfer, which results in unnecessary power consumption and signaling overhead.

To help reduce this unnecessary signaling overhead and power consumption, in some cases, a UE may be permitted to communicate user data in an SDT in the inactive state without having to move to the connected state. In some cases, the UE may need to perform a random access channel (RACH) procedure to establish a connection with the NTBS and acquire a time advance (TA) to communicate the user data in the SDT. Resources for performing the RACH procedure may be limited and shared among UEs within a cell served by the NTBS. In non-terrestrial networks, a cell size may be very large (e.g., up to 90 km in diameter) and may include a very many UEs, which may exacerbate the issue of limited RACH resources. As a consequence, RACH capacity may be limited in an NTN cell, especially if the NTBS needs has to configure SDT resources to be separate from legacy RACH resources (e.g., non-SDT communication). Additionally, interference of uplink channels may be potentially large and unpredictable in contention-based RACH resources. Further, due to increased round trip delays (RTDs) associated with NTN communication, there may be cases in which a UE uses an invalid time advance (TA) for communication, which may cause unreliable communication of user data in a small data transfer.

Accordingly, aspects of the present disclosure provide techniques for facilitating small data transmission by UEs communicating in an NTN while in an inactive or idle state. These techniques may help to reduce the issues describe above with SDT in non-terrestrial network, such as issues with transmitting using an invalid TA, limited RACH resources, and interference on uplink channels

### Introduction to Wireless Communication Networks

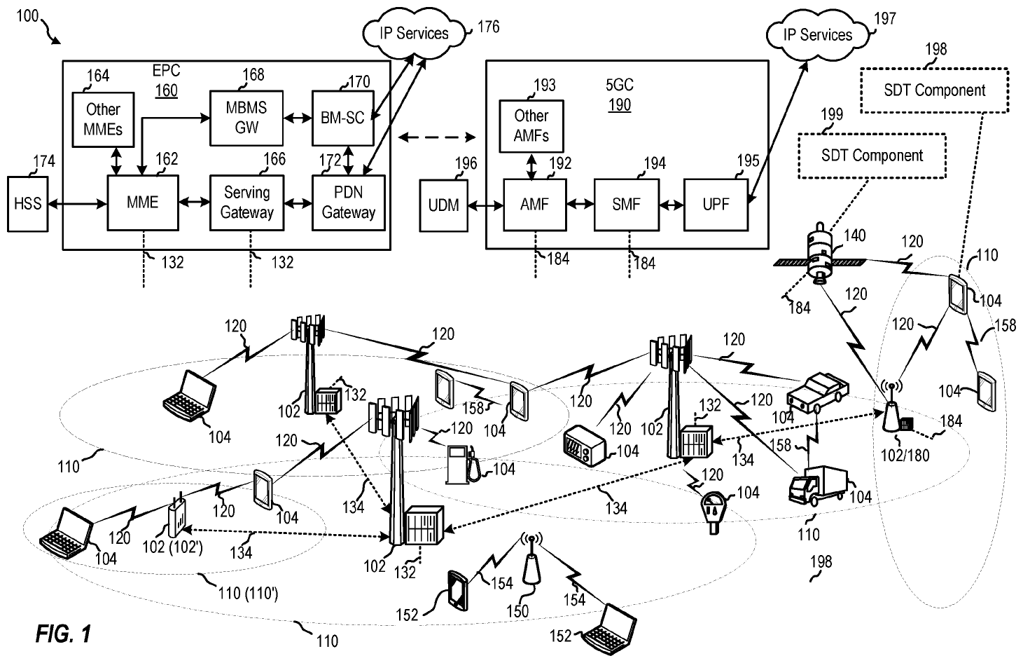

FIG. 1 depicts an example of a wireless communication network 100, in which aspects described herein may be implemented.

Generally, wireless communication network 100 includes base stations (BSs) 102, user equipments (UEs) 104, one or more core networks, such as an Evolved Packet Core (EPC) 160 and 5G Core (5GC) network 190, which interoperate to provide wireless communications services.

Base stations 102 and satellite 140 may provide an access point to the EPC 160 and/or 5GC 190 for a user equipment 104, and may perform one or more of the following functions: transfer of user data, radio channel ciphering and deciphering, integrity protection, header compression, mobility control functions (e.g., handover, dual connectivity), inter-cell interference coordination, connection setup and release, load balancing, distribution for non-access stratum (NAS) messages, NAS node selection, synchronization, radio access network (RAN) sharing, multimedia broadcast multicast service (MBMS), subscriber and equipment trace, RAN information management (RIM), paging, positioning, delivery of warning messages, among other functions. Base stations may include and/or be referred to as a gNB, NodeB, eNB, ng-eNB (e.g., an eNB that has been enhanced to provide connection to both EPC 160 and 5GC 190), an access point, a base transceiver station, a radio base station, a radio transceiver, or a transceiver function, or a transmission reception point in various contexts.

Base stations 102 and satellite 140 wirelessly communicate with UEs 104 via communications links 120. Similarly, in some cases, base stations 102 may also wirelessly communicate with the satellite 140 via a communication link 120. Each of base stations 102 may provide communication coverage for a respective geographic coverage area or 110, which may overlap in some cases. For example, small cell 102′ (e.g., a low-power base station) may have a coverage area 110′ that overlaps the coverage area 110 of one or more macrocells (e.g., high-power base stations).

The communication links 120 between base stations 102/satellite 140 and UEs 104 may include uplink (UL) (also referred to as reverse link) transmissions from a user equipment 104 to a base station 102 and/or downlink (DL) (also referred to as forward link) transmissions from a base station 102 to a user equipment 104. The communication links 120 may use multiple-input and multiple-output (MIMO) antenna technology, including spatial multiplexing, beamforming, and/or transmit diversity in various aspects.

Examples of UEs 104 include a cellular phone, a smart phone, a session initiation protocol (SIP) phone, a laptop, a personal digital assistant (PDA), a satellite radio, a global positioning system, a multimedia device, a video device, a digital audio player, a camera, a game console, a tablet, a smart device, a wearable device, a vehicle, an electric meter, a gas pump, a large or small kitchen appliance, a healthcare device, an implant, a sensor/actuator, a display, or other similar devices. Some of UEs 104 may be internet of things (IoT) devices (e.g., parking meter, gas pump, toaster, vehicles, heart monitor, or other IoT devices), always on (AON) devices, or edge processing devices. UEs 104 may also be referred to more generally as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, or a client.

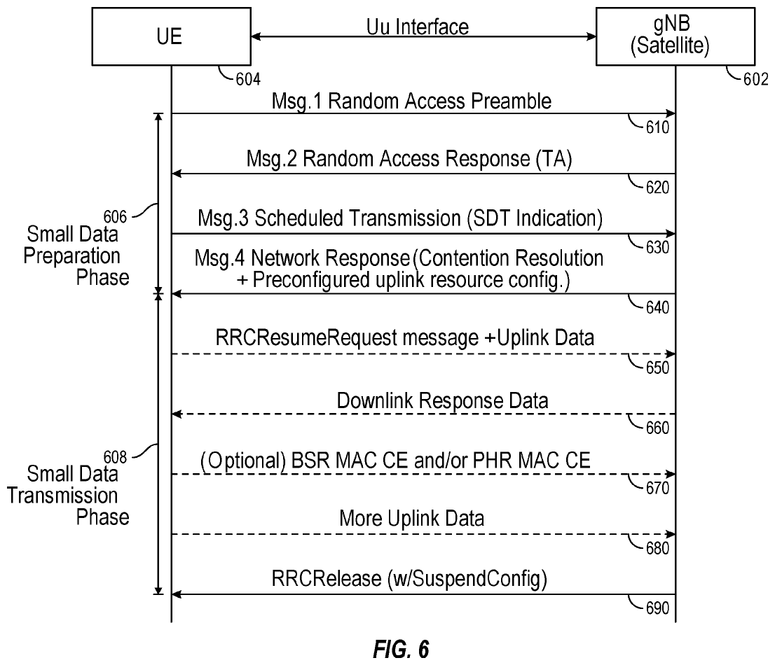

Wireless communication network 100 includes a small data transfer (SDT) communication component 199, which may be configured to perform the operations in one or more of FIGS. 6-9, 10, and 12, as well as other operations described herein for communicating an SDT in a non-terrestrial network (NTN). Wireless communication network 100 further includes an SDT communication component 198, which may be used configured to perform the operations in one or more of FIGS. 6-9, 11, and 13, as well as other operations described herein for communicating an SDT in an NTN.

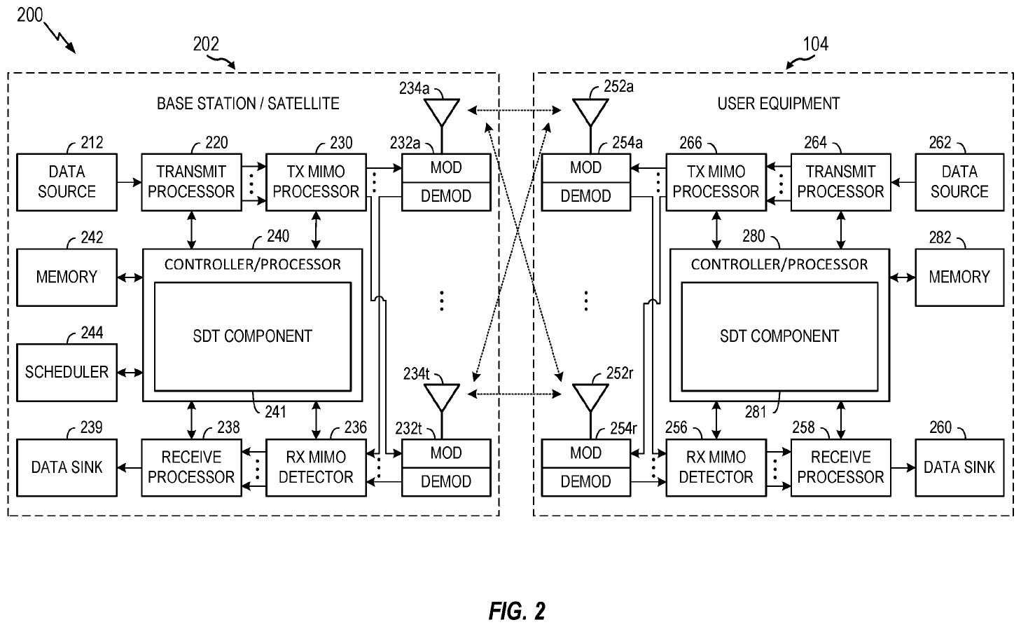

FIG. 2 depicts aspects of an example wireless communication device 202 and a user equipment (UE) 104. In some cases, the wireless communication device 202 may comprise the base station 102. In other cases, the wireless communication device may comprise the satellite 140.

Generally, wireless communication device 200 includes various processors (e.g., 220, 230, 238, and 240), antennas 234a-t (collectively 234), transceivers 232a-t (collectively 232), which include modulators and demodulators, and other aspects, which enable wireless transmission of data (e.g., data source 212) and wireless reception of data (e.g., data sink 239). For example, wireless communication device 200 may send and receive data between itself and user equipment 104.

Wireless communication device 200 includes controller/processor 240, which may be configured to implement various functions related to wireless communications. In the depicted example, controller/processor 240 includes an SDT communication component 241, which may be representative of the SDT communication component 199 of FIG. 1. Notably, while depicted as an aspect of controller/processor 240, the SDT communication component 241 may be implemented additionally or alternatively in various other aspects of base station 102 in other implementations.

Generally, user equipment 104 includes various processors (e.g., 258, 264, 266, and 280), antennas 252a-r (collectively 252), transceivers 254a-r (collectively 254), which include modulators and demodulators, and other aspects, which enable wireless transmission of data (e.g., data source 262) and wireless reception of data (e.g., data sink 260).

User equipment 104 includes controller/processor 280, which may be configured to implement various functions related to wireless communications. In the depicted example, controller/processor 280 includes an SDT communication component 281, which may be representative of the SDT communication component 198 of FIG. 1. Notably, while depicted as an aspect of controller/processor 280, the SDT communication component 281 may be implemented additionally or alternatively in various other aspects of user equipment 104 in other implementations.

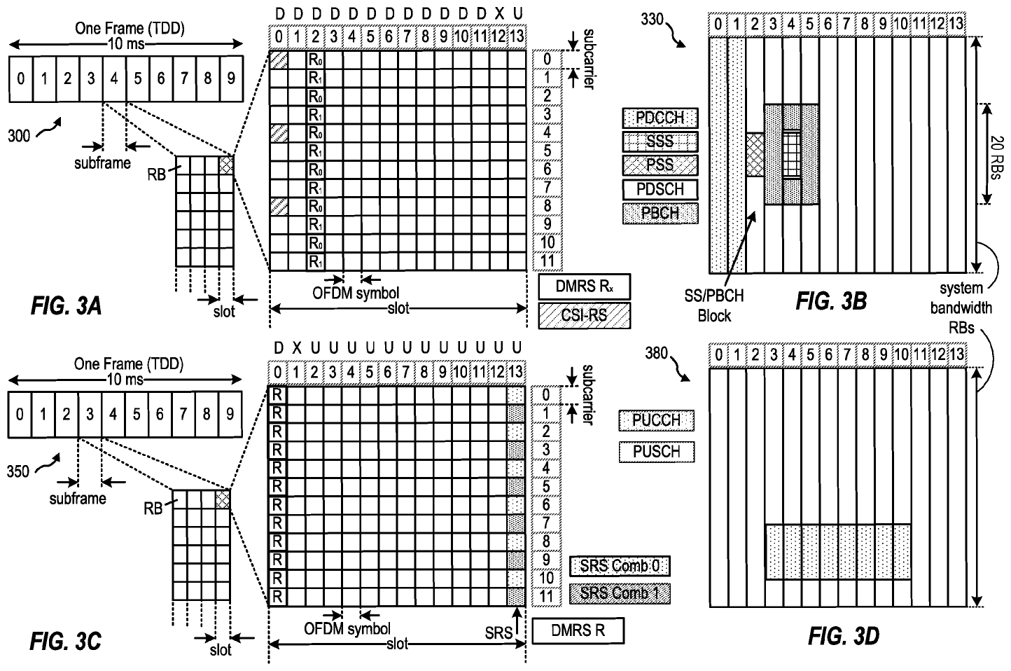

FIGS. 3A-3D depict aspects of data structures for a wireless communication network, such as wireless communication network 100 of FIG. 1. In particular, FIG. 3A is a diagram 300 illustrating an example of a first subframe within a 5G (e.g., 5G NR) frame structure, FIG. 3B is a diagram 330 illustrating an example of DL channels within a 5G subframe, FIG. 3C is a diagram 350 illustrating an example of a second subframe within a 5G frame structure, and FIG. 3D is a diagram 380 illustrating an example of UL channels within a 5G subframe.

Further discussions regarding FIG. 1, FIG. 2, and FIGS. 3A-3D are provided later in this disclosure.

### Introduction to Non-Terrestrial Networks

In some cases, communication in a wireless communication network, such as the wireless communication network 100 illustrated in FIG. 1, may be facilitated by one or more non-terrestrial (NT) devices. In such cases, this wireless communication network may be referred to as a NT network (NTN). NT devices may include, for example, devices such as a space satellite (e.g., satellite 140 illustrated in FIG. 1), a balloon, a dirigible, an airplane, a drone, an unmanned aerial vehicle, and/or the like.

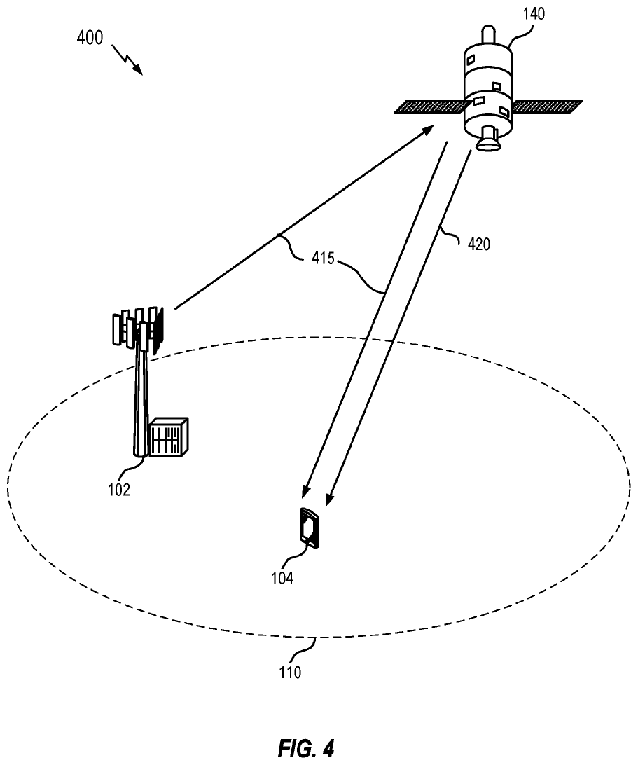

FIG. 4 illustrates an example of an NTN 400 including satellite 140, in which aspects of the present disclosure may be practiced. In some examples, the NTN 400 may implement aspects of the wireless communication network 100. For example, the NTN 400 may include BS 102, UE 104, and satellite 140. BS 102 may serve a coverage area or cell 110 in cases of a terrestrial network, and satellite 140 may serve the coverage area or cell 110 in cases of an NTN. Some NTNs may employ airborne platforms (e.g., a drone or balloon) and/or space borne platforms (e.g., a satellite).

The satellite 140 may communicate with the BS 102 and UE 104 as part of wireless communications in the NTN 400. In cases of a terrestrial network, the UE 104 may communicate with the BS 102 over a communication link (e.g., communication link 120 in FIG. 1). In the case of NTN wireless communications, the satellite 140 may be the serving cell for the UE 104 via a communication links 420 (e.g., communication link 120 in FIG. 1). In certain aspects, the satellite 140 may act as a relay for the BS 102 and the UE 104, relaying both data transmission and control signaling 415.

The satellite 140 may orbit the earth's surface at a particular altitude. The distance between the satellite 140 and UE 104 may be much greater than the distance between BS 102 and UE 104. The distance between the UE 104 and the satellite 140 may cause an increased round-trip delay (RTD) in communications on the communication links 420 between the UE 104 and the satellite 140. The motion of the satellite 140 may cause a Doppler effect and contribute to a frequency shift in communications between the UE 104 and the satellite 140. The frequency shift may be also contributed to by error related to the local oscillation of either the UE 104 or the satellite 140. The RTD and frequency shift associated with communications in NTNs may lead to inefficiency in transmissions, latency, and inability to accurately transmit and receive messages.

The UE 104 may determine to connect to the satellite 140 using a random access (RA) procedure (e.g., a four-step RA procedure or a two-step RA procedure). The initiation of the RA procedure may begin with the transmission of a RA preamble (e.g., an NR preamble for RA) by the UE 104 to the satellite 140 or BS 102. The UE 104 may transmit the RA preamble on a physical random access channel (PRACH). In some PRACH designs, there may be no estimation or accounting for the RTD or the frequency shift associated with NTNs. In certain networks, such as terrestrial NR networks (e.g., 5G NR), SSBs transmitted by a cell are transmitted on the same frequency interval (e.g., occupying the same frequency interval). In NTN, a satellite may use multiple antennas to form multiple narrow beams and the beams may operate on different frequency intervals to mitigate interference among the beams.

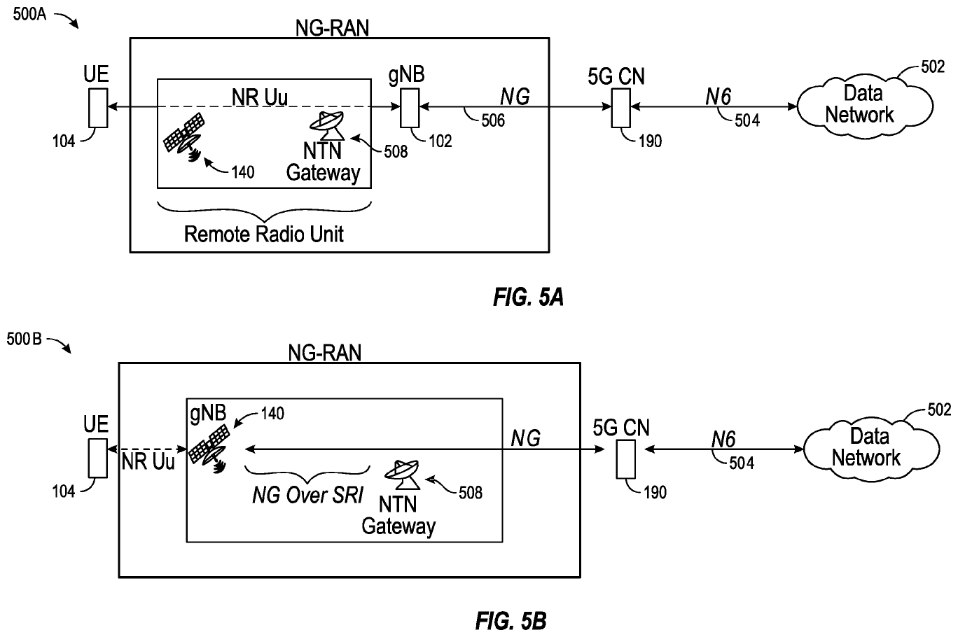

In some cases, different architectures may exist for NTNs, such as a transparent satellite based NTN architecture and a regenerative satellite based NTN architecture. An example of the transparent satellite based NTN architecture is illustrated in FIG. 5A while an example of the regenerative satellite based NTN architecture is illustrated in FIG. 5B. In some cases, the NTN architectures shown in FIGS. 5A and 5B may be implemented in the NTN 400 shown in FIG. 4. In general, the transparent satellite based NTN architecture (e.g., also known as a bent-pipe satellite architecture) involves the satellite 140 may receive a signal from a BS 102 and may relay the signal to a UE 104 or another BS 102, or vice-versa. In the regenerative satellite based NTN architecture, satellite 140 may be configured to relay signals like the bent-pipe transponder or satellite, but may also use on-board processing to perform other functions, such as demodulating a received signal, decoding a received signal, re-encoding a signal to be transmitted, or modulating the signal to be transmitted, or a combination thereof.

For example, as shown in FIG. 5A, in a transparent satellite based NTN architecture 500A, communication between a UE 104 and a data network (DN) 502 may begin with data being sent from the DN 502 over a communication link 504 to user plane function (UPF) in a 5G core network (5G CN), such as the UPF 195 in 5GC 190 illustrated in FIG. 1. In some cases, the communication link 504 between the DN 502 and the UPF in the 5GC 190 may be associated with an N6 interface. Thereafter, the data may be forwarded from the 5GC 190 to BS 102 via a communication link 506 associated with an NG interface. The data may then be sent by the BS 102 to the UE 104 on a new radio (NR) Uu interface via an NTN gateway 508 and satellite 140. For example, the NTN gateway 508 may receive the data from the BS 102 and may forward the data to the satellite 140 on a feeder link via a satellite radio interface (SRI). The SRI on the feeder link is the NR Uu interface. Thereafter, the satellite 140 may perform radio frequency filtering, frequency conversion, and amplification on the received data before relaying the data to the UE 104 on a service link. Hence, the satellite 140 in the transparent satellite based NTN architecture 500A merely repeats the data on the NR-Uu radio interface from the feeder link (e.g., between the NTN gateway 508 and the satellite 140) to the service link (e.g., between the satellite 140 and the UE 104) and vice versa. In other words, the data is un-changed by the satellite 140 and is simply relayed to the UE 104.

In the regenerative satellite based NTN architecture 500B illustrated in FIG. 5B, the data from the DN 502 may be sent from the 5G CN directly to the satellite 140 via NTN gateway 508 without first being processed by BS 102. For example, the NTN gateway 508 may send the data to the satellite 140 on a feeder link that implements an SRI interface. After receiving the data, the satellite 140 may perform radio frequency filtering, frequency conversion and amplification as well as demodulation/decoding, switch and/or routing, coding/modulation. This is effectively equivalent to having all or part of BS 102 functions (e.g. gNB) on board the satellite 140. Thereafter, the satellite 140 transmits the data to the UE 104 on an NR-Uu radio interface via a service link between the UE 104 and the satellite 140.

### Aspects Related to Small Data Transfer for NTN-Based Communication

Certain wireless communication networks, such as fifth generation (5G) new radio (NR), may support a radio resource control (RRC) inactive state (e.g., RRC_INACTIVE) that allows user equipments (UEs) with infrequent data transmission to enter a low-power state to conserve power. A main principle of the inactive state is that a UE is able to return to a connected state as quickly and efficiently as possible. For example, when the UE transitions to inactive, both the UE and the wireless communication network store information necessary to quickly resume a connection. The message that transitions the UE to inactive state may contain a set of parameters used for inactive state operation. These parameters may include, for example, radio access network (RAN) Notification Area (RNA), which specifies an area within which the UE is allowed to move without notifying the network. Additionally, these parameters may be used for secure transition back to the connected state, such as a UE identifier and security information needed to support encrypted resume messages.

However, until recently, the RRC inactive state has not supported the transmission of user data while operating in this state. Hence, the UE has to resume the connection (i.e. move to RRC_CONNECTED state) for any downlink (DL) (e.g., mobile terminating (MT)) data and uplink (UL) (e.g., mobile originating (MO)) data, regardless of the amount of user data for transfer. In other words, regardless of the amount of user data or how infrequent the user data transfer is, the UE must perform a connection setup procedure and be subsequently released to the RRC inactive state for each data transfer, which results in unnecessary power consumption and signaling overhead. Signaling overhead from the RRC inactive state for small data packets is a general problem in 5G NR wireless communication networks and, as more UEs are added, may become a critical issue in 5G NR not only for network performance and efficiency but also for the UE battery performance.

To help reduce this unnecessary signaling overhead and power consumption, in some cases, a UE may be permitted to communicate user data in a small data transfer (SDT) in the RRC inactive state without having to move to the RRC connected state. A non-limiting set of SDT examples may include: traffic from instant messaging (IM) services, heart-beat/keep-alive traffic from IM/email clients and other applications, push notifications from various applications, traffic from wearables (e.g., periodic positioning information), sensors (e.g., industrial wireless sensor networks that transmit temperature, pressure readings periodically or in an event triggered manner), and smart meters and smart meter networks sending periodic meter readings.

In some cases, there may be different procedures for communicating user data in an SDT, such as (1) a random access channel (RACH) based SDT procedure that allows a UE to communicate the user data in the SDT after completing a two-step or four-step RACH procedure from the RRC inactive state, and (2) a configured grant (CG) based SDT procedure that allows transmission of UL data on pre-configured physical uplink shared channel (PUSCH) by reusing a CG grant type 1. However, while there may be procedures to allow SDT when in an RRC inactive state, these procedures may present certain issues with some wireless communication networks, such a non-terrestrial networks (NTN) like NTN 400 illustrated in FIG. 4.

For example, in an NTN, the number of UEs within an NTN cell/beam may be quite large considering that a typical cell/beam size is 90 kilometers in diameter. As such, RACH capacity may be limited, especially if an NTN base station/satellite (e.g., satellite 140) needs to configure SDT resources to be separate from the legacy RACH users. Additionally, interference of uplink channels may be potentially large and unpredictable in contention-based RACH resources. Further, regarding the two-step RACH procedure, an associated two-step RACH payload may be transmitted using an invalid time advance (TA), which may cause unreliable small data transfer.

Accordingly, aspects of the present disclosure provide techniques for facilitating small data transfer by UEs communicating in an NTN while in an inactive or idle state. These techniques may help to reduce the issues describe above with SDT in non-terrestrial network, such as issues with transmitting using an invalid TA, limited RACH resources, and interference on uplink channels. In some cases, such techniques may involve providing NTN UEs with SDT information to facilitate the SDT in an idle or inactive state. In some cases, the SDT information may include information regarding a set of resources for communicating user data in an SDT as well as a valid TA for uplink user data transmission. In some cases, by providing the UE with a set of resources, the UE may transmit uplink data without frequent signaling exchange, which may be beneficial in NTNs where a round trip delays (RTDs) are high. Additionally, by providing the valid TA, the reliability that an SDT is received properly may be increased.

Providing the UE in an NTN with the SDT information may be performed in different manners, such as via one or more SDT procedures that involve non-dedicated RACH resource or via one or more SDT procedures that involve dedicated RACH resources. The one or more SDT procedures that involve non-dedicated RACH resources may involve providing the SDT information during a four-step RACH procedure as well as a two-step RACH procedure. Additionally, the one or more SDT procedures that involve the dedicated RACH resources may include providing the SDT information in an RRC release message before the UE transitions to the RRC inactive state or providing the SDT information within a paging message. In any case, the SDT procedures involving the dedicated and non-dedicated RACH resources may each comprise two different phases, such as a small data preparation phase and a small data transmission phase.

For example, as will be described in greater detail below, the small data preparation phase may, in some cases, include a base station/satellite providing an NTN UE with an indication of a set of dedicated RACH resources. For MT data, the set of dedicated RACH resources may be indicated within a paging message set to the UE. In some cases, a common or separate RACH resource pool for SDT may be provided in the NTN. When the UE performs a RACH procedure for an SDT, the UE may acquire the valid TA for uplink user data transmission and may provide an SDT indication. The SDT indication may include information, such as the purpose of the RACH procedure (e.g., for SDT in NTN), a traffic profile for the SDT (e.g., whether the SDT includes one-shot traffic or multiple shot traffic), and/or a traffic periodicity and amount of data each shot. In response to the SDT indication, the UE may receive a set of preconfigured resources for performing the SDT.

Within the small data transmission phase, in some cases, the UE may use an RRC resume procedure when in the inactive state to resume connection with the base station/satellite in the NTN and to perform the SDT. In other cases, the UE may report a UE identity (e.g., UE ID) and additional security information together with a first uplink transmission of the SDT without using the RRC resume procedure. To perform the SDT, the UE may transmit or receive the small data using the preconfigured resources. Additionally, in some cases, during the small data transmission phase, the base station/satellite may schedule downlink user data for the UE or may retransmit user data. Further, in some cases, the UE may indicate a buffer status report (BSR) and a power headroom report (PHR). The BSR may indicating a buffer status of the UE associated with newly-arrived data for transmission during the small data transmission phase. The PHR may indicate a remaining power level of the UE for uplink transmissions.

Additional details regarding the small data preparation phase and small data transmission phase in relation to the SDT procedures involving non-dedicated RACH resources and dedicated RACH resources are described below.

### SDT Procedure with Non-Dedicated RACH Resources for NTN

As noted above, SDT in an NTN may be facilitated by one or more SDT procedures involving non-dedicated RACH resources. These one or more SDT procedures may include providing a UE with information for enabling an SDT via a four-step RACH procedure or a two-step RACH procedure. The four-step RACH procedure and two-step RACH procedure may be performed without the use of dedicated RACH resources for SDT. Instead, as will be explained in greater detail below, when performing the four-step RACH procedure or the two-step RACH procedure with a non-terrestrial base station (NTBS) (e.g., a satellite) of an NTN, the UE may use a common set of RACH resources and may provide an SDT indication to the NTBS to indicate that the purpose of the RACH is for SDT. In other cases, when performing the four-step RACH procedure or the two-step RACH procedure, the UE may use a separate set of RACH resources.

In some cases, the common set of RACH resources may include RACH resources that may be used for both SDT communication as well as non-SDT communication. In some cases, by using a common set of RACH resources to perform a RACH procedure and providing an indication that the RACH procedure is for initiating an SDT, RACH resource allocation efficiency may be increased, especially considering RACH resources within an NTN cell may be limited and one NTBS may serve a potentially huge number of UEs.

In other cases, a separate or distinct set of RACH resources may be used for performing a RACH procedure to initiate an SDT. In some cases, the separate set of RACH resources may include RACH resources that may only be used for SDT communication. In other words, the separate set of RACH resources may include resources for performing a RACH procedure to initiate an SDT that are distinct from resources for performing a RACH procedure for non-SDT communication. For example, in some cases, the separate set of RACH resources may include RACH occasions (ROs) that are distinct from ROs for non-SDT communication. Additionally, the separate set of RACH resources may include RACH preambles that are distinct from RACH preambles used for non-SDT communication. In such cases, when a UE performs a RACH procedure using the separate set of RACH resources (e.g., a RO and/or a preamble that are distinct from ROs and preambles used for non-SDT communication) the NTBS may know that the purpose of the RACH procedure is for initiating an SDT. By using a separate set of RACH resources for initiating an SDT, contention and potential interference may be reduced, for example, as opposed to the common set of RACH resources.

In some cases, whether the UE selects the four-step RACH procedure or the two-step RACH procedure for communicating user data in an SDT may depend on at least one criterion. For example, in some cases, the UE may select between the four-step RACH procedure and the two-step RACH procedure based on a reference signal received power (RSRP) associated with reference signals received from the NTBS. For example, in some cases, if the RSRP is above a threshold (e.g., indicating good signal quality), the UE may select the two-step RACH procedure; otherwise the UE may select the four-step RACH procedure. However, in some cases, selecting between the four-step RACH procedure and the two-step RACH procedure based on RSRP may not work well for NTN applications as there may not be a clear difference between RSRP of cell-center and cell-edge UEs in an NTN, which may result in all UEs within a cell using the same type of RACH procedure.

Thus, in some cases, the UE may select between the four-step RACH procedure and two-step RACH procedure based on additional criterion, such as location information of the UE within a cell and/or a round trip time (RTT) between the UE and NTBS. For example, it may be beneficial for a UE to use the two-step RACH procedure for initiating the SDT when the RTT is below a threshold (e.g., shorter RTTs) to quickly acquire a valid TA in order to further reduce the latency associated with the SDT in NTN. In some cases, the RTT between a UE and an NTBS may be lower when a location of the UE is closer to the position of the NTBS when mapped to the ground as compared to when the location of the UE is further away to the position of the NTBS when mapped to the ground. In other words, when the location of the UE is closer to the location of the NTBS, a RTT between the UE and the NTBS may be shorter. Thus, when this RTT is below a threshold, the UE may select the two-step RACH procedure to initiate the SDT; otherwise, the UE may select the four-step RACH procedure to initiate the SDT.

FIG. 6 is a call flow diagram illustrating example operations 600 between a NTBS 602 and a UE 604 for communicating user data in an NTN SDT while the UE 604 is in an idle or inactive mode using a four-step RACH procedure. In some cases, the NTBS 602 may be an example of a non-terrestrial base station, such as the satellite 140 in the wireless communication network 100 illustrated in FIG. 1 and the NTN 400 illustrated in FIG. 4. Similarly, the UE 604 may be an example of the UE 104 illustrated in FIG. 1 and FIG. 4. Further, as shown, a Uu interface may be established to facilitate communication between the NTBS 602 and UE 604, however, in other aspects, a different type of interface may be used. In some cases, communication between the NTBS 602 and UE 604 on the Uu interface may be facilitated by a service link.

As shown, the operations 600 in FIG. 6 may be divided into a small data preparation phase 606 and a small data transmission phase 608. During the small data preparation phase 606, the UE 604 may perform the four-step RACH procedure to obtain a set of resources for transmitting user data in the SDT during the small data transmission phase 608.

Operations 600 may begin in the small data preparation phase 606 with the UE 604 transmitting, at 610, a first message of the four-step RACH procedure (e.g., MSG1) to the NTBS 602. The first message may be transmitted during a particular RACH occasion and may include a RACH preamble. In some cases, the particular RACH occasion and RACH preamble may be part of a common set of RACH resources (e.g., RACH resources for both SDT communication and non-SDT communication) or a separate set of RACH resources (e.g., only for SDT communication).

At 620, the NTBS 602 responds to the random access preamble by transmitting a RACH response message (e.g., MSG2) to the UE 604. The RACH response message may include a TA for the UE 604 to use for uplink transmissions, such as an SDT.

Thereafter, at 630, the UE 604 transmits a small data transfer (SDT) indication message including a first indication that the UE 604 has user data to transmit in an SDT while in an idle or inactive mode. In other words, the first indication may indicate to the NTBS 602 that the purpose of the RACH procedure is to allow the UE 604 to communicated user data in an SDT while in an idle or inactive mode. As shown, the SDT indication message may be transmitted in a third message (e.g., MSG3) of the RACH procedure.

In some cases, the SDT indication message may include additional information. For example, the SDT indication message may also include a second indication of whether there will be additional (small) user data for communication subsequent to the transmission of the user data in the SDT, which may help the NTBS determine how many resources to allocate communication of user data in the SDT. For example, when the UE 604 indicates there will be additional user data for communication subsequent to the transmission of the user data, the UE 604 may specify an amount of the additional user data. In some cases, the SDT indication message may also include a third indication of a traffic profile associated with the SDT. The traffic profile associated with the SDT may indicate whether the SDT comprises one-shot traffic or multiple-shot traffic. Additionally, the SDT indication message may include a traffic periodicity and amount of user data associated with each shot of the one-shot traffic or multiple-shot traffic. In some cases, the SDT indication message may also include other early reporting information if a grant size associated with the SDT indication message (e.g., resource grant for MSG3 transmission) is large enough to accommodate this other early reporting information. In some cases, this other early reporting information may include, for example, a radio resource management (RRM) measurement report, a positioning report, minimization of drive test (MDT) reporting, and the like.

In response to the SDT indication message informing the NTBS 602 that the UE 604 will be communicating user data in an SDT, at 640, the NTBS 602 transmits a resource indication message, after contention resolution, including an indication of a set of resources for transmitting the user data in the SDT while the UE 604 is in the idle or inactive mode, as shown at 640. The set of resources may indicate time and frequency resources for the UE 604 to use when transmitting the user data in the SDT to the NTBS 602. Additionally, in some cases, the resource indication message may further include an indication of a common or UE-specific search space associated with the UE as well as a UE-specific radio temporary identifier (RNTI) associated with the UE. Further, the resource indication message may also include information for configuring a timer associated with the TA (e.g., sent to the UE 604 at 620) for communicating with the NTBS 602. In some cases, expiration of the timer indicates that the TA received by the UE at 620 and the set of resources for transmitting the user data in the SDT are invalid and may not be used by the UE 604 for transmitting the SDT.

Thereafter, operations 600 may continue to the small data transmission phase 608. For example, as illustrated at 650, the UE 604 transmits the user data in the SDT to the NTBS 602 via the set of resources indicated in the resource indication message and using the indicated TA (e.g., provided the timer associated with the TA has not expired and, thus, the TA is valid). In some cases, the UE 604 transmits the user data in the SDT while in the idle or inactive mode. In some cases, there may be different transmission schemes for transmitting the user data in the SDT. For example, a first transmission scheme may involve using an RRC resume procedure. During the RRC resume procedure, the UE 604 may transmit an RRC message (e.g., RRC resume request), as shown at 650, that includes message includes a resume identifier (ID) associated with the UE 604 and an authentication token associated with the UE 604. The UE may also transmit the user data of the SDT together with the RRC message.

Another transmission scheme that may be used for transmitting the user data in the SDT, while not shown in FIG. 6, does not involve the transmission of an RRC message. For example, in this transmission scheme, the UE 604 may simply transmit the uplink user data of the SDT together with an identifier of the UE 604 and security information associated with the UE 604.

After transmitting the user data in the SDT to the NTBS 602, the UE 604 may receive downlink user data from the NTBS 602, as illustrated at 660. The downlink user data may be transmitted to the UE 604 in response to the uplink user data of the SDT.

In some cases, after transmitting the uplink user data of the SDT, new uplink user data may arrive in the UE 604 for transmission to the NTBS 602. In such cases, as shown at 670, the UE 604 may transmit a BSR, indicating a buffer status of the UE 604 associated with newly-arrived user data for transmission via a data radio bearer (DRB) associated with the SDT or other DRBs. In some cases, the UE 604 may also transmit at 670 a PHR, indicating a remaining power level of the UE for uplink transmissions.

As shown at 680, if the UE 604 has additional uplink user data to transmit, based on the BSR, the UE 604 may transmit this additional uplink user data to the NTBS 602. After the UE 604 is finished transmitting uplink user data and when the UE 604 initiated the SDT via the RRC resume transmission scheme at 650, the NTBS 602 may transmit, at 690, an RRC release message to transition the UE 604 back into the idle or inactive state. The RRC release message may include a suspend configuration that includes one or more parameters. As noted above, the parameters may include, for example, radio access network notification area, which specifies an area within which the UE is allowed to move without notifying the network. Additionally, these parameters may be used for secure transition back to the connected state, such as a UE identifier and security information needed to support encrypted resume messages.

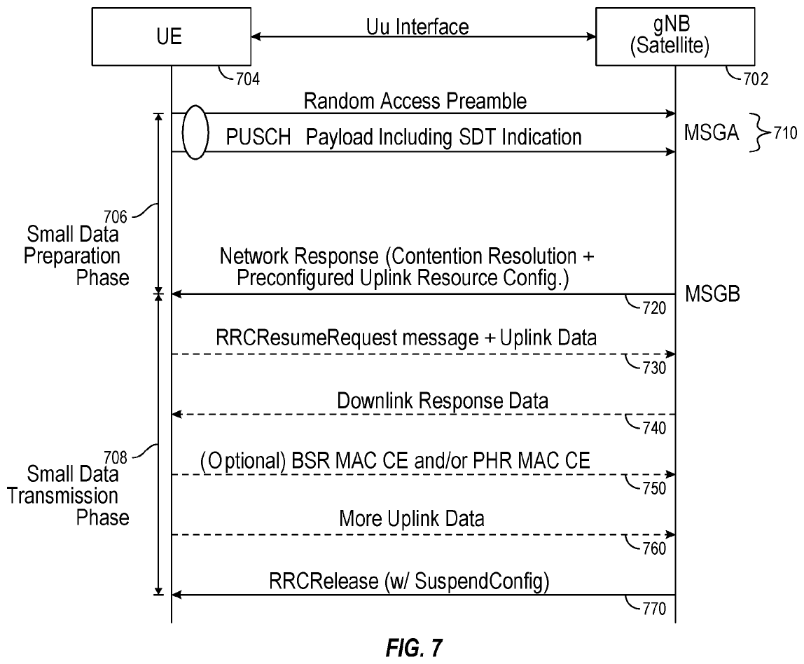

FIG. 7 is a call flow diagram illustrating example operations 700 between a NTBS 702 and a UE 704 for communicating user data in an NTN SDT while the UE 704 is in an idle or inactive mode using a two-step RACH procedure. In some cases, the NTBS 702 may be an example of a non-terrestrial base station, such as the satellite 140 in the wireless communication network 100 illustrated in FIG. 1 and the NTN 400 illustrated in FIG. 4. Similarly, the UE 704 may be an example of the UE 104 illustrated in FIG. 1 and FIG. 4. Further, as shown, a Uu interface may be established to facilitate communication between the NTBS 702 and UE 704, however, in other aspects, a different type of interface may be used. In some cases, communication between the NTBS 702 and UE 704 on the Uu interface may be facilitated by a service link.

As with FIG. 6, operations 700 in FIG. 6 may be divided into a small data preparation phase 706 and a small data transmission phase 708. During the small data preparation phase 706, the UE 704 may perform the two-step RACH procedure to obtain a set of resources for transmitting user data in the SDT during the small data transmission phase 708.

Operations 700 may begin in the small data preparation phase 706 with the UE 704 transmitting, at 710, a first message of the two-step RACH procedure (e.g., MSGA) to the NTBS 702. The first message of the two-step RACH procedure may include a RACH preamble portion and a physical uplink shared channel (PUSCH) payload portion. The first message may be transmitted during a particular RACH occasion and may include a RACH preamble in the payload portion. In some cases, the particular RACH occasion and RACH preamble may be part of a common set of RACH resources (e.g., RACH resources for both SDT communication and non-SDT communication) or a separate set of RACH resources (e.g., only for SDT communication).

In some cases, the UE 704 may transmit an SDT indication message in the payload portion of the first message to indicate that the RACH procedure is for communicating user data in an SDT. Additionally, in some cases, the UE 704 may estimate and apply an initial TA when transmitting the first message to the NTBS. Accordingly, the PUSCH portion of the first message transmitted at 710 may provide an indication of the estimated initial TA for communicating with the NTBS 702. In some cases, the estimated initial TA may be a common TA for NTN service. In any case, the estimated initial TA may assist the NTBS in determining an accurate TA for the UE 704 to communicate with the NTBS 702 (e.g., for performing the SDT in the small data transmission phase 708).

In some cases, the first message may include additional information. For example, the first message may also include a second indication of whether there will be additional (small) user data for communication subsequent to the transmission of the user data in the SDT, which may help the NTBS 702 determine how many resources to allocate for communicating the user data in the SDT. For example, when the UE 704 indicates there will be additional user data for communication subsequent to the transmission of the user data in the SDT, the UE 704 may specify an amount of the additional user data. In some cases, the SDT indication message may also include a third indication of a traffic profile associated with the SDT. The traffic profile associated with the SDT may indicate whether the SDT comprises one-shot traffic or multiple-shot traffic. Additionally, the SDT indication message may include a traffic periodicity and amount of user data associated with each shot of the one-shot traffic or multiple-shot traffic.

Thereafter, at 720, if contention resolution is successful, the NTBS 702 transmits, to UE 704, a second message of the two-step RACH procedure in response to the first message. The second message of the two-step RACH procedure may include a set of resources for transmitting the user data in the SDT while the UE 704 is in the idle or inactive mode. The set of resources may indicate time and frequency resources for the UE 704 to use when transmitting the user data in the SDT to the NTBS 702. Additionally, the NTBS 702 may also include at least one of an indication of the accurate TA for the UE 704 to use when communicating with the NTBS 702 or an offset to be applied by the UE 704 to the initial TA to determine the accurate TA.

Additionally, in some cases, the second message may further include an indication of a common or UE-specific search space associated with the UE 704 as well as a UE-specific radio temporary identifier (RNTI) associated with the UE 704. Further, the second message may also include information for configuring a timer associated with the accurate TA for communicating with the NTBS 702. In some cases, expiration of the timer indicates that the accurate TA received by the UE at 720 and the set of resources for transmitting the user data in the SDT are invalid and may not be used by the UE 704 for transmitting the SDT.

Thereafter, operations 700 may continue to the small data transmission phase 708. For example, as illustrated at 730, the UE 704 transmits the user data in the SDT to the NTBS 702 via the set of resources indicated in the resource indication message and using the accurate TA (e.g., provided the timer associated with the accurate TA has not expired and, thus, the accurate TA is valid). In some cases, the UE 704 transmits the user data in the SDT while in the idle or inactive mode. In some cases, there may be different transmission schemes for transmitting the user data in the SDT. For example, a first transmission scheme may involve using an RRC resume procedure. During the RRC resource procedure, the UE 704 may transmit an RRC message (e.g., RRC resume request), as shown at 730, that includes message includes a resume ID associated with the UE 704 and an authentication token associated with the UE 704. The UE may also transmit uplink user data of the SDT together with the RRC message.

Another transmission scheme that may be used for transmitting the SDT, while not shown in FIG. 7, does not involve the transmission of an RRC message. For example, in this transmission scheme, the UE 704 may simply transmit the uplink user data of the SDT together with an identifier of the UE 704 and security information associated with the UE 704.

After transmitting the uplink user data of the SDT to the NTBS 702, the UE 704 may receive downlink from the NTBS 702, as illustrated at 740. The downlink user data may be transmitted to the UE 704 in response to the uplink user data of the SDT.

In some cases, after transmitting the uplink user data of the SDT, new uplink user data may arrive in the UE 704 for transmission to the NTBS 702. In such cases, as shown at 750, the UE 704 may transmit a BSR, indicating a buffer status of the UE 704 associated with newly-arrived user data for transmission via the DRB associated with the SDT or other DRBs. In some cases, the UE 704 may also transmit, at 750, a PHR, indicating a remaining power level of the UE for uplink transmissions.

As shown at 760, if the UE 704 has additional uplink user data to transmit, based on the BSR, the UE 704 may transmit this additional uplink user data to the NTBS 702. After the UE 704 is finished transmitting uplink user data and when the UE 704 initiated the SDT via the RRC resume transmission scheme at 730, the NTBS 702 may transmit, at 770, an RRC release message to transition the UE 704 back into the idle or inactive state.

SDT Procedure with Dedicated RACH Resources for NTN

As noted above, SDT in an NTN may be facilitated by one or more SDT procedures involving dedicated RACH resources. These one or more SDT procedures may include providing a UE with SDT information prior to the UE performing a RACH procedure to initiate an SDT to communicate user data. For example, the SDT information may include a first indication of a set of resources for communicating user data in an SDT while the UE is in an idle or inactive mode. The SDT information may also include a second indication of one or more dedicated RACH resources for initiating the SDT. In some cases, the one or more dedicated RACH resources may be specifically allocated to a UE that allows the UE to perform a RACH procedure without contention.

In some cases, the one or more dedicated RACH resources may include one or more RACH occasions (ROs) and/or one or more RACH preambles that are allocated by an NTBS to a specific UE for initiating an SDT. The one or more ROs and one or more RACH preambles may be partitioned or separated from ROs and RACH preambles used for non-SDT communication. As such, when the UE uses the one or more dedicated RACH resources for initiating the SDT, the RACH procedure may be more-efficient as the UE does not need to provide a separate indication that the RACH procedure is for SDT since the NTBS will know that the RACH procedure is for communicating user data in an SDT due to the use of the dedicated RACH resources. Additionally, because the dedicated RACH resources are partitioned from RACH resources for non-SDT communication and are allocated to a specific UE, contention may be significantly reduced, if not eliminated, when using these RACH resources, thereby reducing potential interference and the time that it takes to complete the RACH procedure. Moreover, as noted above, the UE is provided with the set of resources for communicating user data in an SDT prior to the RACH procedure, which reduces the amount of signaling and time needed to complete the RACH procedure (e.g., since the set of resources for communicating the SDT do not need to be provided in the RACH procedure).

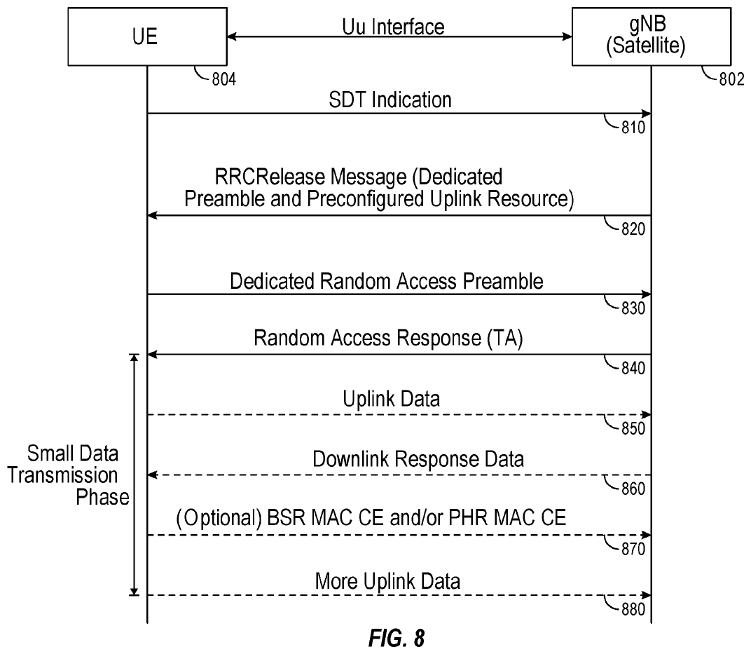

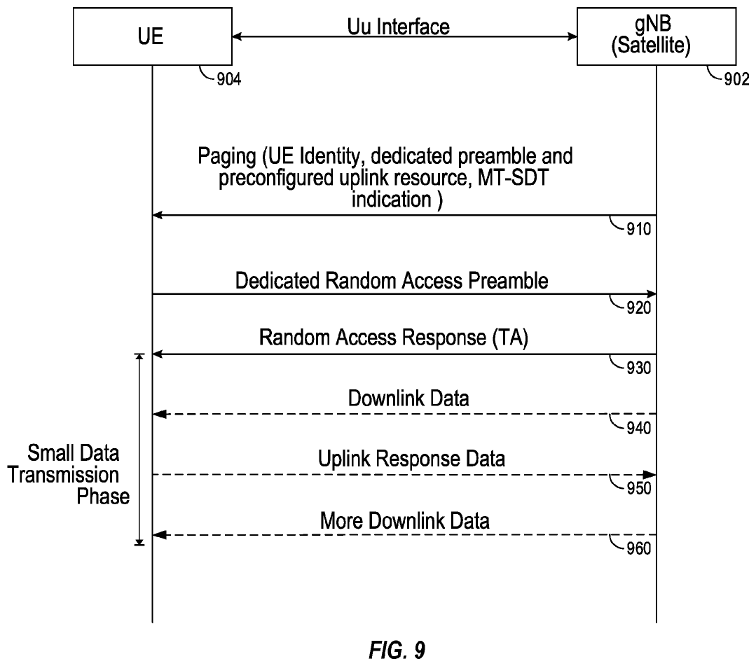

Different options for performing one or more SDT procedures involving dedicated RACH resources may exist. For example, in some cases, as illustrated in FIG. 8, the one or more SDT procedures that involve the dedicated RACH resources may include providing the SDT information (e.g., dedicated RACH resources and set of resources for communicating the SDT) in an RRC release message before the UE transitions to the RRC inactive state. In other cases, as illustrated in FIG. 9, the one or more SDT procedures that involve the dedicated RACH resources may include providing the SDT information within a paging message transmitted to the UE.

FIG. 8 is a call flow diagram illustrating example operations 800 between a NTBS 802 and a UE 804 for communicating user data in an NTN SDT while the UE is in an idle or inactive mode using dedicated RACH resources indicated in an RRC connection release message. In some cases, the NTBS 802 may be an example of a non-terrestrial base station, such as the satellite 140 in the wireless communication network 100 illustrated in FIG. 1 and the NTN 400 illustrated in FIG. 4. Similarly, the UE 804 may be an example of the UE 104 illustrated in FIG. 1 and FIG. 4. Further, as shown, a Uu interface may be established to facilitate communication between the NTBS 802 and UE 804, however, in other aspects, a different type of interface may be used. In some cases, communication between the NTBS 802 and UE 804 on the Uu interface may be facilitated by a service link.

Operations 800 begin at 810 with the UE 804 transmitting an SDT indication message to the NTBS 802. The SDT indication message may be transmitted to the NTBS 802 while the UE 804 is in a connected mode. The SDT indication message may include an indication that the UE 804 intends to transmit user data in an SDT while in an idle or inactive mode. As such, the SDT indication message may request one or more dedicated RACH resources for performing a RACH procedure to initiate the SDT, such as a dedicated RACH preamble. Additionally, the SDT indication message may also request a set of resources for communicating the user data in the SDT while the UE is in an idle or inactive mode.

Thereafter, at 820, in response to the SDT indication message, the NTBS 802 transmits, to the UE 804, signaling indicating the one or more dedicated RACH resources for initiating the SDT as well the set of resources for communicating the SDT. As noted above, the one or more dedicated RACH resources for performing the RACH procedure may be separate and distinct from resources for performing a RACH procedure for non-SDT communication. In some cases, the signaling may be transmitted in an RRC connection release message while the UE 804 is in a connected mode. Based on the RRC connection release message, the UE 804 may transition to an idle or inactive mode. In some cases, the RRC connection release message may include updated security information for initiating the SDT to communicate the user data.

Thereafter, as some point in the future, the UE 804 may determine that uplink user data needs to be communicated in an SDT while the UE 804 is in the idle or inactive mode. Accordingly, as shown at 830, based on the determination, the UE 804 may perform a RACH procedure by transmitting a dedicated RACH preamble (e.g., indicated in the one or more dedicated RACH resources) to the NTBS 802. The dedicated RACH preamble may inform the NTBS 802 that the purpose of the RACH procedure is for communicating user data in an SDT.

Thereafter, as shown at 840, based on the dedicated RACH preamble, the UE 804 receives a RACH response message from the NTBS 802 indicating a TA for communicating the user data in the SDT. The UE may then communicate uplink user data of the SDT, as shown at 850, via the set of resources indicated in the RRC connection release message and using the indicated TA. The remaining operations shown in FIG. 8, such as operations 860, 870, and 800, generally correspond to operations 660, 670, and 670, respectively, illustrated in FIG. 6.

FIG. 9 is a call flow diagram illustrating example operations 900 between a NTBS 902 and a UE 904 for communicating user data in an NTN SDT while the UE is in an idle or inactive mode using dedicated RACH resources indicated in a paging message. In some cases, the NTBS 902 may be an example of a non-terrestrial base station, such as the satellite 140 in the wireless communication network 100 illustrated in FIG. 1 and the NTN 400 illustrated in FIG. 4. Similarly, the UE 904 may be an example of the UE 104 illustrated in FIG. 1 and FIG. 4. Further, as shown, a Uu interface may be established to facilitate communication between the NTBS 902 and UE 904, however, in other aspects, a different type of interface may be used. In some cases, communication between the NTBS 902 and UE 904 on the Uu interface may be facilitated by a service link.

As noted above, in some cases, the SDT information (e.g., dedicated RACH resources and set of resources for communicating the SDT) may be transmitted to a UE, such as the UE 904, in a paging message. In some cases, the SDT information may be provided in a paging message when, for example, mobile-terminating (MT) data needs to be transmitted to the UE on the downlink from the NTBS 902. In other words, the paging message may serve as a notification that the NTBS 902 will be transmitting an SDT to the UE 904.

For example, as shown in FIG. 9, operations 900 begin at 910 with the NTBS 902 transmitting a paging message to the UE 904 while the UE 904 is in an idle or inactive mode. In some cases, the paging message may include one or more dedicated RACH resources for initiating an SDT (e.g., a dedicated preamble) as well a set of resources for communicating user data in the SDT. As noted above, the one or more dedicated RACH resources for performing the RACH procedure may be separate and distinct from resources for performing a RACH procedure for non-SDT communication. Additionally, if user data to be transmitted in the SDT is associated with an MT service (e.g., the user data is MT data transmitted from the NTBS 902 to the UE 904), a MT SDT indication may be included within the paging message. The MT SDT may indicate to the UE 904 that an SDT will occur and that the SDT will include MT data transmitted from the NTBS 902 to the UE 904.

Thereafter, in response to receiving the paging message, the UE 904 may perform a RACH procedure with the NTBS 902 by transmitting, at 920, a dedicated RACH preamble (e.g., indicated in the one or more dedicated RACH resources) to the NTBS 902. The dedicated RACH preamble may inform the NTBS 902 that the purpose of the RACH procedure is for communicating user data in an SDT.

Thereafter, as shown at 930, based on the dedicated RACH preamble, the UE 904 receives a RACH response message from the NTBS 902 indicating a TA for communicating the user data in the SDT. The UE may then receive downlink user data in the SDT, as shown at 940, via the set of resources indicated in the RRC connection release message and using the indicated TA. After receiving the user data in the SDT from the NTBS 902, the UE 704 may transmit uplink user data to the NTBS 902, as illustrated at 950. The uplink user data may be transmitted to the NTBS 902 in response to the downlink user data transmitted to the UE 904 in the SDT. Thereafter, if the NTBS 902 has any additional downlink user data for the UE 904, the NTBS 902 may transmit the additional downlink user data to the UE 904 at 960.

SDT Procedures in Handover Scenarios with Dedicated RACH Resources

In some cases, one or more of the SDT procedures described above may be applicable to situations in which a UE is handed over to a target NTBS from a source NTBS. For example, satellites (e.g., NTBSs) in non-geostatic orbits move with high speed relative to a fixed position on earth, leading to frequent and unavoidable handover for both stationary and moving UEs. In some cases, even for a large cell with 1000 km diameter size, handover can happen every 2.2 minutes. As such, there may by instances in which a UE is handed over to a target NTBS from a source NTBS and the UE wants to communicate user data in an SDT while the UE is in an idle or inactive mode. In such cases, it may be beneficial for the source NTBS to provide the UE with SDT information associated with the target NTBS so that the UE may communicate user data in an SDT with the target NTBS without first having to receive the SDT information from the target NTBS.

In some cases, techniques for providing the SDT information associated with the target NTBS may be similar to those described above in relation to FIG. 8, except that in the handover scenario, the SDT information may be transmitted in an RRC reconfiguration message as opposed to being transmitted in an RRC release message at 820. In other words, in the handover scenario, the RRC release message transmitted at 820 in FIG. 8 may, instead, be an RRC reconfiguration message that initiates a handover of the UE to the target NTBS.

For example, as with FIG. 8, the UE may provide the source NTBS (e.g., the NTBS that the UE is currently camped on) with an SDT indication message, requesting one or more dedicated RACH resources (e.g., a dedicated RACH preamble) and a set of resources for communicating user data in an SDT. In some cases, after receiving the SDT indication message, the source NTBS may determine that the UE will need to be handed over to a target NTBS. In such cases, in response to the SDT indication message, the source NTBS may transmit signaling to the UE indicating one or more dedicated RACH resources (e.g., a dedicated RACH preamble) associated with the target NTBS as well as a set of resources, associated with the target NTBS, for communicating the user data in the SDT. In some cases, the signaling may be transmitted in an RRC reconfiguration message, which initiates the handover of the UE to the target NTBS.

Accordingly, in response to receiving the RRC reconfiguration message, the UE may be handed over to the target NTBS. Thereafter, the UE may determine that an user data needs to be communicated in an SDT. In such cases, the UE may transmit the dedicated RACH preamble associated with the target NTBS to the target NTBS. The dedicated RACH preamble may indicate to the target NTBS that the purpose of the RACH is for initiating an SDT. The target NTBS may then respond to the UE with a TA for communicating uplink user data of the SDT. Thereafter, the UE may then communicate the uplink user data in the SDT to the target NTBS using the TA and the set of resources for communicating the SDT indicated by the source NTBS.

### Example Methods for Communicating an SDT in an NTN Based on Non-Dedicated RACH Resources

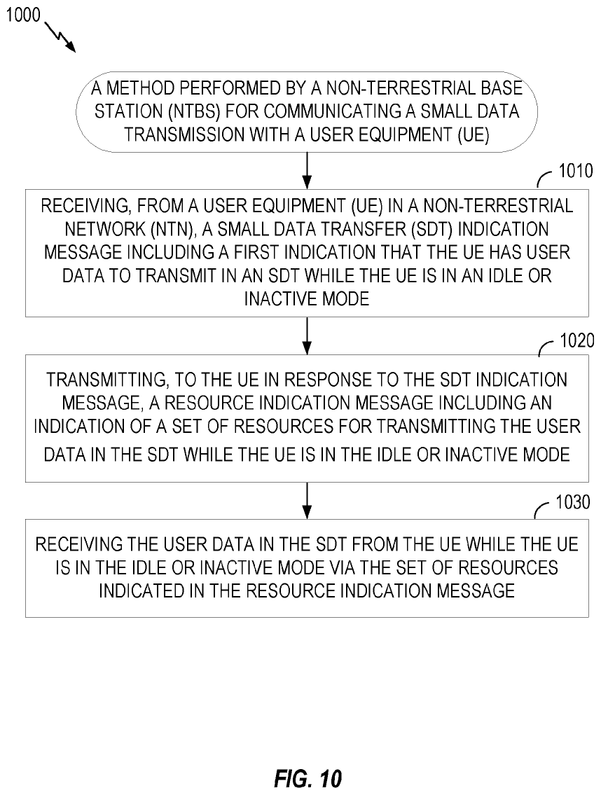

FIG. 10 is a flow diagram illustrating example operations 1000 for wireless communication. The operations 1000 may be performed, for example, by a NTBS (e.g., such as the satellite 140 in the wireless communication network 100 of FIG. 1) for communicating an SDT in an NTN based on non-dedicated RACH resources. The operations 1000 may be implemented as software components that are executed and run on one or more processors (e.g., controller/processor 240 of FIG. 2). Further, the transmission and reception of signals by the BS in operations 1000 may be enabled, for example, by one or more antennas (e.g., antennas 234 of FIG. 2). In certain aspects, the transmission and/or reception of signals by the BS may be implemented via a bus interface of one or more processors (e.g., controller/processor 240, including the SDT communication component 241) obtaining and/or outputting signals.

Operations 1000 begin in block 1010 with the NTBS receiving, from a user equipment (UE) in a non-terrestrial network (NTN), a small data transfer (SDT) indication message including a first indication that the UE has user data to transmit in an SDT while the UE is in an idle or inactive mode.

In block 1020, the NTBS transmits, to the UE in response to the SDT indication message, a resource indication message including an indication of a set of resources for transmitting the user data in the SDT while the UE is in the idle or inactive mode.

In block 1030, the NTBS receives the user data in the SDT from the UE while the UE is in the idle or inactive mode via the set of resources indicated in the resource indication message.

In some cases, the SDT indication message further includes: a second indication of whether there will be additional user data for communication subsequent to the transmission of the user data in the SDT, a third indication of a traffic profile associated with the SDT, indicating whether the SDT comprises one-shot traffic or multiple-shot traffic, and a traffic periodicity and amount of user data associated with each shot of the one-shot traffic or multiple-shot traffic.

In some cases, the resource indication message further includes: an indication of a common or UE-specific search space associated with the UE, a UE-specific radio temporary identifier (RNTI) associated with the UE, and information for configuring a timer associated with a time advance (TA) for communicating with the NTBS, wherein expiration of the timer indicates that the TA and the set of resources for transmitting the user data in the SDT are invalid.

In some cases, operations 1000 may further include receiving, from the UE, a random access response (RACH) preamble in a first message of a four-step RACH procedure, transmitting, to the UE in response to the RACH preamble, a second message of the four-step RACH procedure indicating the TA for the UE to use for communicating with the NTBS, receiving, from the UE in response to receiving the second message of the four-step RACH procedure, a third message of the four-step RACH procedure, wherein receiving the SDT indication message comprises receiving the SDT indication message in the in the third message of the four-step RACH procedure, and transmitting, in response to the SDT indication in the third message of the four-step RACH procedure, a fourth message of the four-step RACH procedure, wherein transmitting the resource indication message comprises transmitting the resource indication message in the fourth message of the four-step RACH procedure.

In some cases, operations 1000 may further include receiving, from the UE, a first message of a two-step random access channel (RACH) procedure, wherein the first message of the two-step RACH procedure includes a RACH preamble portion and a physical uplink shared channel (PUSCH) payload portion, and wherein receiving the SDT indication message comprises receiving the SDT indication message in the PUSCH payload portion of the first message of the two-step RACH procedure, and transmitting, to the UE in response to the first message of the two-step RACH procedure, a second message of the two-step RACH procedure, wherein transmitting the resource indication message comprises transmitting the resource indication message in the second message of the two-step RACH procedure.

In some cases, the PUSCH portion of the first message of the two-step RACH procedure provides an indication of an estimated TA for communicating with the NTBS, and the second message of the two-step RACH procedure further includes an indication of an offset to apply to the estimated TA for communicating with the NTBS.

In some cases, operations 1000 may further include receiving, when the UE is operating in the inactive mode, a radio resource control (RRC) message from the UE, wherein the RRC message includes a resume identifier (ID) associated with the UE and an authentication token associated with the UE and transmitting, after receiving the RRC message and the user data in the SDT, an RRC release message terminating the SDT.

In some cases, receiving the user data in the SDT in block 1030 comprises receiving the user data in the SDT together with an identifier of the UE and security information associated with the UE.

In some cases, operations 1000 may further include receiving, from the UE while the UE is in the idle or inactive mode, at least one of: a buffer status report (BSR), indicating a buffer status of the UE associated with newly-arrived user data for transmission via a data radio bearer (DRB) associated with the SDT or other DRBs or a power headroom report (PHR), indicating a remaining power level of the UE for uplink transmissions.

In some cases, resources for a random access channel (RACH) procedure for initiating the SDT are distinct from resources for performing a RACH procedure for non-SDT communication. For example, in some cases, the resources for the RACH procedure for initiating the SDT include at least one of: random access occasions (ROs) that are distinct from ROs for non-SDT communication or RACH preambles that are distinct from RACH preambles for non-SDT communication.

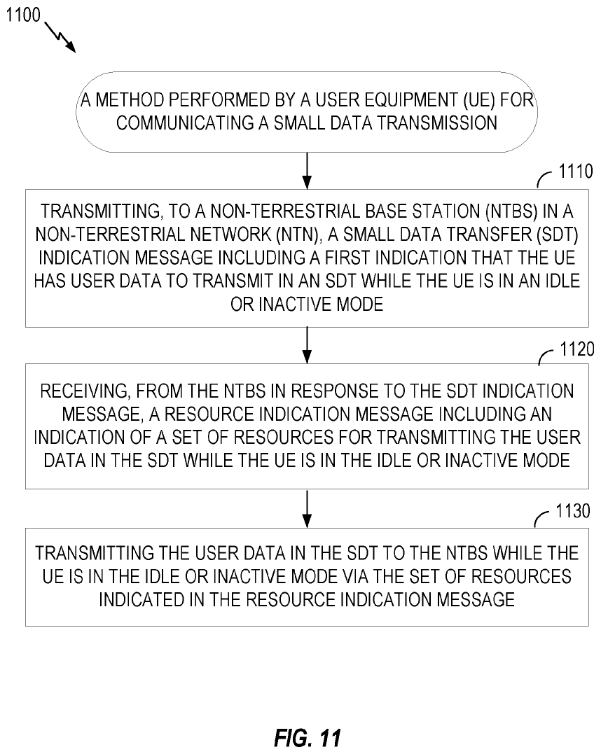

FIG. 11 is a flow diagram illustrating example operations 1100 for wireless communication, in accordance with certain aspects of the present disclosure. The operations 1100 may be performed, for example, by a UE (e.g., such as the UE 104 in the wireless communication network 100 of FIG. 1) for communicating an SDT in an NTN based on non-dedicated RACH resources. The operations 1100 may be complementary to the operations 1000 performed by the NTBS. The operations 1100 may be implemented as software components that are executed and run on one or more processors (e.g., controller/processor 280 of FIG. 2). Further, the transmission and reception of signals by the UE in operations 1100 may be enabled, for example, by one or more antennas (e.g., antennas 252 of FIG. 2). In certain aspects, the transmission and/or reception of signals by the UE may be implemented via a bus interface of one or more processors (e.g., controller/processor 280, including the SDT communication component 281) obtaining and/or outputting signals.

Operations 1100 begin in block 1110 with the UE transmitting, to a non-terrestrial base station (NTBS) in a non-terrestrial network (NTN), a small data transfer (SDT) indication message including a first indication that the UE has user data to transmit in an SDT while the UE is in an idle or inactive mode.

In block 1120, the UE receives, from the NTBS in response to the SDT indication message, a resource indication message including an indication of a set of resources for transmitting the user data in the SDT while the UE is in the idle or inactive mode.

In block 1130, the UE transmits the user data in the SDT to the NTBS while the UE is in the idle or inactive mode via the set of resources indicated in the resource indication message.

In some cases the SDT indication message further includes: a second indication of whether there will be additional user data for communication subsequent to the transmission of the user data in the SDT, a third indication of a traffic profile associated with the SDT, indicating whether the SDT comprises one-shot traffic or multiple-shot traffic, and a traffic periodicity and amount of user data associated with each shot of the one-shot traffic or multiple-shot traffic.

In some cases, the resource indication message further includes: an indication of a common or UE-specific search space associated with the UE, a UE-specific radio temporary identifier (RNTI) associated with the UE, and information for configuring a timer associated with a time advance (TA) for communicating with the NTBS, wherein expiration of the timer indicates that the TA and the set of resources for transmitting the user data in the SDT are invalid.

In some cases, operations 1100 further include selecting either the two-step RACH procedure to transmit the SDT indication message or the four-step RACH procedure to transmit the SDT indication message based on at least one criterion.

In some cases, the at least one criterion comprises at least one of a location of the UE or a round trip time (RTT) between the UE and the NTBS.

In some cases, operations 1100 further include selecting the four-step RACH procedure to transmit the SDT indication message; transmitting, to the NTBS, a RACH preamble in a first message of the four-step RACH procedure, receiving, from the NTBS in response to the RACH preamble, a second message of the four-step RACH procedure indicating the TA for the UE to use for communicating with the NTBS, transmitting, to the NTBS in response to receiving the second message of the four-step RACH procedure, a third message of the four-step RACH procedure, wherein transmitting the SDT indication message comprises transmitting the SDT indication message in the in the third message of the four-step RACH procedure, and receiving, in response to the SDT indication in the third message of the four-step RACH procedure, a fourth message of the four-step RACH procedure, wherein receiving the resource indication message comprises receiving the resource indication message in the fourth message of the four-step RACH procedure.

In some cases, operations 1100 further include selecting the two-step RACH procedure to transmit the SDT indication message, transmitting, to the NTBS, a first message of the two-step RACH procedure, wherein the first message of the two-step RACH procedure includes a RACH preamble portion and a physical uplink shared channel (PUSCH) payload portion, and wherein transmitting the SDT indication message comprises transmitting the SDT indication message in the PUSCH payload portion of the first message of the two-step RACH procedure, and receiving, from the NTBS in response to the first message of the two-step RACH procedure, a second message of the two-step RACH procedure, wherein receiving the resource indication message comprises receiving the resource indication message in the second message of the two-step RACH procedure.

In some cases, the PUSCH portion of the first message of the two-step RACH procedure provides an indication of an estimated TA for communicating with the NTBS, and the second message of the two-step RACH procedure further includes an indication of an offset to apply to the estimated TA for communicating with the NTBS.

In some cases, the operations 1100 further include determining the estimated TA based on a global navigation satellite system (GNSS) capability of the UE.

In some cases, operations 1100 further include transmitting, when the UE is operating in the inactive mode, a radio resource control (RRC) message to the NTBS, wherein the RRC message includes a resume identifier (ID) associated with the UE and an authentication token associated with the UE and receiving, after transmitting the RRC request message and the user data in the SDT, an RRC release message terminating the SDT.

In some cases, transmitting the SDT in block 1130 comprises transmitting the user data in the SDT together with an identifier of the UE and security information associated with the UE.

In some cases, operations 1100 further include transmitting, to the NTBS while the UE is in the idle or inactive mode, at least one of: a buffer status report (BSR), indicating a buffer status of the UE associated with newly-arrived user data for transmission via a data radio bearer (DRB) associated with the SDT or other DRBs or a power headroom report (PHR), indicating a remaining power level of the UE for uplink transmissions.

In some cases, resources for performing a random access channel (RACH) procedure for initiating the SDT are distinct from resources for performing a RACH procedure for non-SDT communication. For example, in some cases, the resources for performing the RACH procedure for initiating the SDT include at least one of: random access occasions (ROs) that are distinct from ROs for non-SDT communication or RACH preambles that are distinct from RACH preambles for non-SDT communication.

### Example Methods for Communicating an SDT in an NTN Based on Dedicated RACH Resources

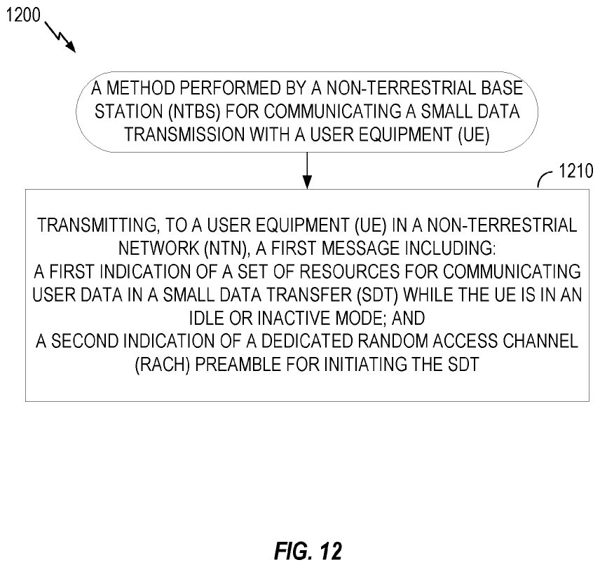

FIG. 12 is a flow diagram illustrating example operations 1200 for wireless communication. The operations 1200 may be performed, for example, by a NTBS (e.g., such as the satellite 140 in the wireless communication network 100 of FIG. 1) for communicating an SDT in an NTN based on dedicated RACH resources. The operations 1200 may be implemented as software components that are executed and run on one or more processors (e.g., controller/processor 240 of FIG. 2). Further, the transmission and reception of signals by the BS in operations 1200 may be enabled, for example, by one or more antennas (e.g., antennas 234 of FIG. 2). In certain aspects, the transmission and/or reception of signals by the BS may be implemented via a bus interface of one or more processors (e.g., controller/processor 240, including the SDT communication component 241) obtaining and/or outputting signals.

Operations 1200 begin in block 1210 with the NTBS transmitting, to a user equipment (UE) in a non-terrestrial network (NTN), a first message including a first indication of a set of resources for communicating user data in a small data transfer (SDT) while the UE is in an idle or inactive mode and a second indication of a dedicated random access channel (RACH) preamble for initiating the SDT.

In some cases, operations 1200 further include communicating the user data in the SDT while the UE is in the idle or inactive mode via the set of resources indicated in the first message.

In some cases, transmitting the first message in block 1210 comprises transmitting the first message while the UE is in a connected mode and the first message comprises a radio resource control (RRC) release message.

In some cases, operations 1200 further include receiving, from the UE while the UE is in the connected mode, an SDT indication message, requesting the dedicated RACH preamble and the set of resources for communicating the user data in the SDT.

In some cases, communicating the user data in the SDT comprises receiving the user data in the SDT from the UE.

In some cases, transmitting the first message comprises transmitting the first message in a paging message to the UE. In such cases, the first message further includes a mobile terminating (MT)-SDT indication, indicating that the user data comprises MT data for the UE. Further, in some cases, communicating the user data in the SDT comprises transmitting, based on the MT-SDT indication, the MT data in the SDT to the UE.

In some cases, operations 1200 further include performing a RACH procedure with the UE for initiating the SDT, wherein performing the RACH procedure comprises: receiving, from the UE, the dedicated RACH preamble to initiate the SDT and transmitting, based on the dedicated RACH preamble, a RACH response message indicating a time advance (TA) for communicating the user data in the SDT, wherein communicating the user data in the SDT comprises communicating the user data in the SDT with the UE based on the TA transmitted in the RACH response message.

In some cases, resources for performing the RACH procedure for initiating the SDT are distinct from resources for performing a RACH procedure for non-SDT communication. For example, in some cases, the resources for performing the RACH procedure for initiating the SDT include at least one of: random access occasions (ROs) that are distinct from ROs for non-SDT communication or RACH preambles, including the dedicated RACH preamble, that are distinct from RACH preambles for non-SDT communication.

In some cases, the first message comprises a radio resource control (RRC) reconfiguration message, instructing the UE to handover to a second NTBS from the first NTBS, and the set of resources for communicating a SDT and the dedicated RACH preamble are associated with the second NTBS.

In some cases, operations 1200 further include receiving, from the UE while the UE is in the idle or inactive mode, at least one of: a buffer status report (BSR), indicating a buffer status of the UE associated with newly-arrived user data for transmission via a data radio bearer (DBR) associated with the SDT or other DBRs or a power headroom report (PHR), indicating a remaining power level of the UE for uplink transmissions.

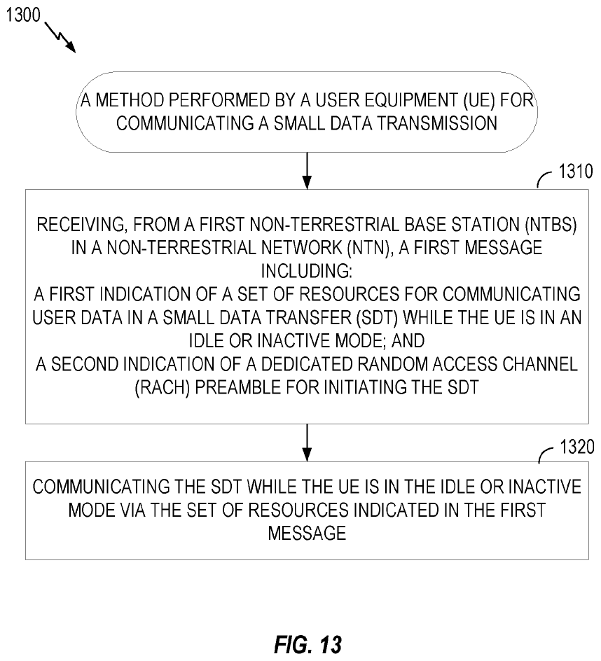

FIG. 13 is a flow diagram illustrating example operations 1300 for wireless communication, in accordance with certain aspects of the present disclosure. The operations 1100 may be performed, for example, by a UE (e.g., such as the UE 104 in the wireless communication network 100 of FIG. 1) for communicating an SDT in an NTN based on dedicated RACH resources. The operations 1300 may be complementary to the operations 1200 performed by the NTBS. The operations 1300 may be implemented as software components that are executed and run on one or more processors (e.g., controller/processor 280 of FIG. 2). Further, the transmission and reception of signals by the UE in operations 1300 may be enabled, for example, by one or more antennas (e.g., antennas 252 of FIG. 2). In certain aspects, the transmission and/or reception of signals by the UE may be implemented via a bus interface of one or more processors (e.g., controller/processor 280, including the SDT communication component 281) obtaining and/or outputting signals.

Operations 1300 begin in block 1310 with the UE receiving, from a first non-terrestrial base station (NTBS) in a non-terrestrial network (NTN), a first message including: a first indication of a set of resources for communicating user data in a small data transfer (SDT) while the UE is in an idle or inactive mode and a second indication of a dedicated random access channel (RACH) preamble for initiating the SDT.

In block 1320, the UE communicates the user data in the SDT while the UE is in the idle or inactive mode via the set of resources indicated in the first message.

In some cases, receiving the first message in block 1310 comprises receiving the first message while the UE is in a connected mode and the first message comprises a radio resource control (RRC) release message.

In some cases, operations 1300 further include transmitting, to the first NTBS while the UE is in the connected mode, an SDT indication message, requesting the dedicated RACH preamble and the set of resources for communicating the user data in the SDT.

In some cases, communicating the user data in the SDT in block 1320 comprises transmitting the user data in the SDT to the first NTBS.

In some cases, receiving the first message in block 1310 comprises receiving the first message in a paging message from the first NTBS.

In some cases, the first message further includes a mobile terminating (MT)-SDT indication, indicating that the user data comprises MT data for the UE. In such cases, communicating the user data in the SDT in block 1320 comprises receiving, based on the MT-SDT indication, the user data in the SDT from the first NTBS.

In some cases, operations 1300 further include performing a RACH procedure with the NTBS for initiating the SDT. In some cases, performing the RACH procedure comprises: transmitting, to the first NTBS, the dedicated RACH preamble to initiate the SDT and receiving, based on the dedicated RACH preamble, a RACH response message indicating a time advance (TA) for communicating the user data in the SDT, wherein communicating the user data in the SDT comprises communicating the user data in the SDT with the first NTBS based on the TA received in the RACH response message.

In some cases, resources for performing the RACH procedure for initiating the SDT are distinct from resources for performing a RACH procedure for non-SDT communication. For example, in some cases, the resources for performing the RACH procedure for initiating the SDT include at least one of: random access occasions (ROs) that are distinct from ROs for non-SDT communication or RACH preambles, including the dedicated RACH preamble, that are distinct from RACH preambles for non-SDT communication.

In some cases, the first message comprises a radio resource control (RRC) reconfiguration message, instructing the UE to handover to a second NTBS from the first NTBS. In such cases, the set of resources for communicating the user data in the SDT and the dedicated RACH preamble are associated with the second NTBS. Additionally, in such cases, communicating the user data in the SDT in block 1320 comprises communicating the user data in the SDT with the second NTBS after handing over to the second NTBS.

In some cases, operations 1300 further include transmitting, to the first NTBS while the UE is in the idle or inactive mode, at least one of: a buffer status report (BSR), indicating a buffer status of the UE associated with newly-arrived user data for transmission via a data radio bearer (DBR) associated with the SDT or other DBRs or a power headroom report (PHR), indicating a remaining power level of the UE for uplink transmissions.

### Example Wireless Communication Devices

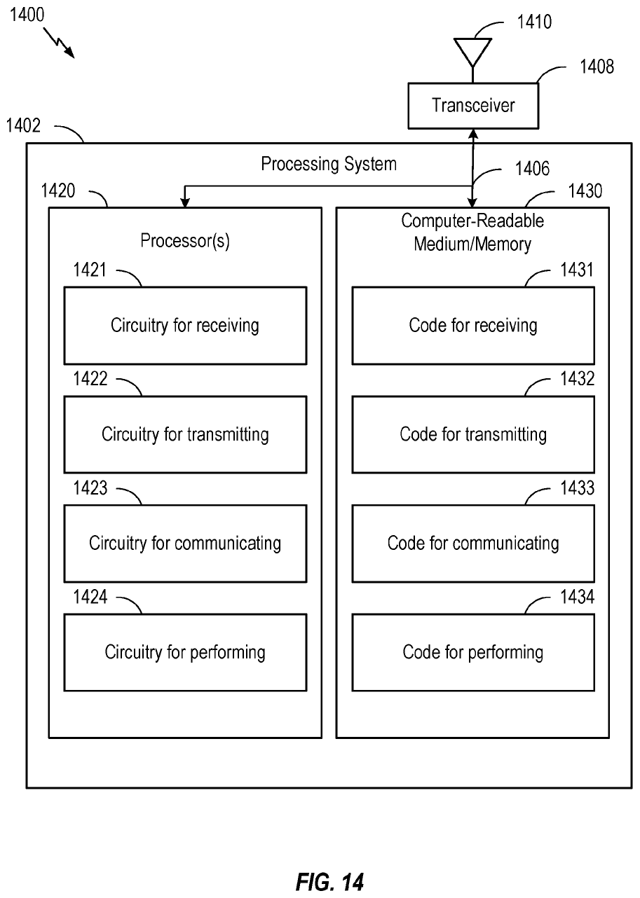

FIG. 14 depicts an example communications device 1400 that includes various components operable, configured, or adapted to perform operations for the techniques disclosed herein, such as the operations depicted and described with respect to FIGS. 6-9, 10, and 12. In some examples, communication device 1400 may be a base station 102 as described, for example with respect to FIGS. 1 and 2.

Communications device 1400 includes a processing system 1402 coupled to a transceiver 1408 (e.g., a transmitter and/or a receiver). Transceiver 1408 is configured to transmit (or send) and receive signals for the communications device 1400 via an antenna 1410, such as the various signals as described herein. Processing system 1402 may be configured to perform processing functions for communications device 1400, including processing signals received and/or to be transmitted by communications device 1400.

Processing system 1402 includes one or more processors 1420 coupled to a computer-readable medium/memory 1430 via a bus 1406. In certain aspects, computer-readable medium/memory 1430 is configured to store instructions (e.g., computer-executable code) that when executed by the one or more processors 1420, cause the one or more processors 1420 to perform the operations illustrated in FIGS. 6-9, 10, and 12, or other operations for performing the various techniques discussed herein for communicating user data in a small data transfer (SDT) in a non-terrestrial network (NTN).

In the depicted example, computer-readable medium/memory 1430 stores code 1431 for receiving, code 1432 for transmitting, code 1433 for communicating, and code 1434 for performing.

In the depicted example, the one or more processors 1420 include circuitry configured to implement the code stored in the computer-readable medium/memory 1430, including circuitry 1421 for receiving, circuitry 1422 for transmitting, circuitry 1423 for communicating, and circuitry 1424 for performing.

Various components of communications device 1400 may provide means for performing the methods described herein, including with respect to FIGS. 6-9, 10, and 12.

In some examples, means for transmitting or sending (or means for outputting for transmission), as well as means for communicating, may include the transceivers 232 and/or antenna(s) 234 of the base station 102 illustrated in FIG. 2 and/or transceiver 1408 and antenna 1410 of the communication device 1400 in FIG. 14.

In some examples, means for receiving (or means for obtaining), as well as means for communicating, may include the transceivers 232 and/or antenna(s) 234 of the base station illustrated in FIG. 2 and/or transceiver 1408 and antenna 1410 of the communication device 1400 in FIG. 14.

In some examples, means for performing may include various processing system components, such as: the one or more processors 1420 in FIG. 14, or aspects of the base station 102 depicted in FIG. 2, including receive processor 238, transmit processor 220, TX MIMO processor 230, and/or controller/processor 240 (including SDT communication component 241).

Notably, FIG. 14 is just one example, and many other examples and configurations of communication device 1400 are possible.

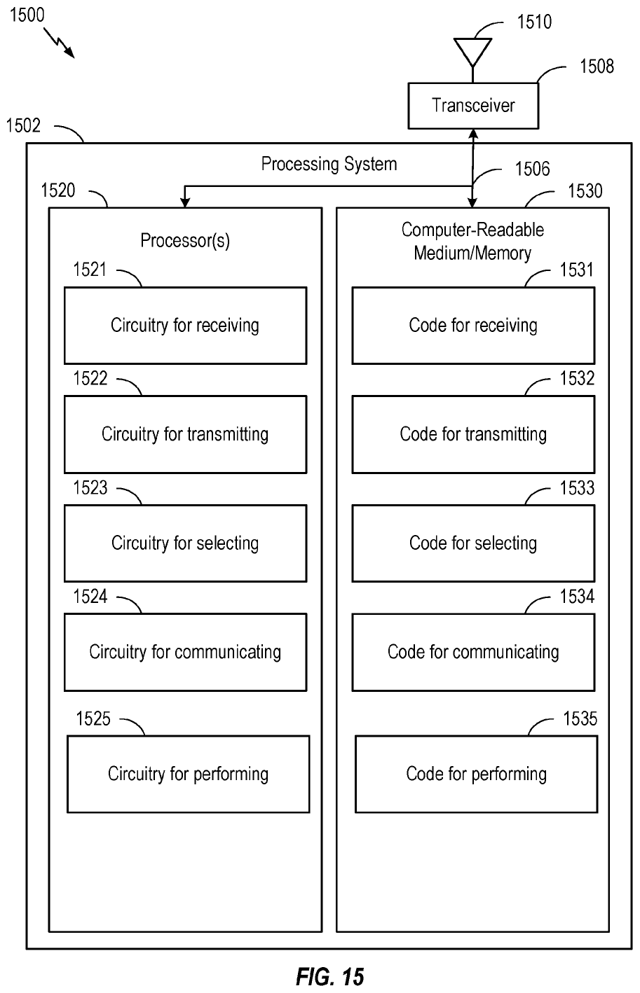

FIG. 15 depicts an example communications device 1500 that includes various components operable, configured, or adapted to perform operations for the techniques disclosed herein, such as the operations depicted and described with respect to FIGS. 6-9, 11, and 13. In some examples, communication device 1500 may be a user equipment 104 as described, for example with respect to FIGS. 1 and 2.

Communications device 1500 includes a processing system 1502 coupled to a transceiver 1508 (e.g., a transmitter and/or a receiver). Transceiver 1508 is configured to transmit (or send) and receive signals for the communications device 1500 via an antenna 1510, such as the various signals as described herein. Processing system 1502 may be configured to perform processing functions for communications device 1500, including processing signals received and/or to be transmitted by communications device 1500.

Processing system 1502 includes one or more processors 1520 coupled to a computer-readable medium/memory 1530 via a bus 1506. In certain aspects, computer-readable medium/memory 1530 is configured to store instructions (e.g., computer-executable code) that when executed by the one or more processors 1520, cause the one or more processors 1520 to perform the operations illustrated in FIGS. 6-9, 11, and 13, or other operations for performing the various techniques discussed herein for communicating user data in an SDT in an NTN.

In the depicted example, computer-readable medium/memory 1530 stores code 1531 for receiving, code 1532 for transmitting, code 1533 for selecting, code 1534 for communicating, and code 1535 for performing.

In the depicted example, the one or more processors 1520 include circuitry configured to implement the code stored in the computer-readable medium/memory 1530, including circuitry 1521 for receiving, circuitry 1522 for transmitting, circuitry 1523 for selecting, circuitry 1524 for communicating, and circuitry 1525 for performing.

Various components of communications device 1500 may provide means for performing the methods described herein, including with respect to FIGS. 6-9, 11, and 13.

In some examples, means for transmitting or sending (or means for outputting for transmission), as well as means for communicating, may include the transceivers 254 and/or antenna(s) 252 of the user equipment 104 illustrated in FIG. 2 and/or transceiver 1508 and antenna 1510 of the communication device 1500 in FIG. 15.

In some examples, means for receiving (or means for obtaining), as well as means for communicating, may include the transceivers 254 and/or antenna(s) 252 of the user equipment 104 illustrated in FIG. 2 and/or transceiver 1508 and antenna 1510 of the communication device 1500 in FIG. 15.

In some examples, means for selecting and means for performing may include various processing system components, such as: the one or more processors 1520 in FIG. 15, or aspects of the user equipment 104 depicted in FIG. 2, including receive processor 258, transmit processor 264, TX MIMO processor 266, and/or controller/processor 280 (including SDT communication component 281).

Notably, FIG. 15 is just one example, and many other examples and configurations of communication device 1500 are possible.

### Example Clauses

Implementation examples are described in the following numbered clauses:

Clause 1: A method for wireless communication by a user equipment (UE), comprising: transmitting, to a non-terrestrial base station (NTBS) in a non-terrestrial network (NTN), a small data transfer (SDT) indication message including a first indication that the UE has user data to transmit in an SDT while the UE is in an idle or inactive mode; receiving, from the NTBS in response to the SDT indication message, a resource indication message including an indication of a set of resources for transmitting the user data in the SDT while the UE is in the idle or inactive mode; and transmitting the user data in the SDT to the NTBS while the UE is in the idle or inactive mode via the set of resources indicated in the resource indication message.

Clause 2: The method of Clause 1, wherein the SDT indication message further includes: a second indication of whether there will be additional user data for communication subsequent to the transmission of the user data in the SDT, a third indication of a traffic profile associated with the SDT, indicating whether the SDT comprises one-shot traffic or multiple-shot traffic, and a traffic periodicity and amount of user data associated with each shot of the one-shot traffic or multiple-shot traffic.

Clause 3: The method of any one of Clauses 1-2, wherein the resource indication message further includes: an indication of a common or UE-specific search space associated with the UE, a UE-specific radio temporary identifier (RNTI) associated with the UE, and information for configuring a timer associated with a time advance (TA) for communicating with the NTBS, wherein expiration of the timer indicates that the TA and the set of resources for transmitting the user data in the SDT are invalid.

Clause 4: The method of any one of Clauses 1-3, further comprising selecting either the two-step RACH procedure to transmit the SDT indication message or the four-step RACH procedure to transmit the SDT indication message based on at least one criterion.

Clause 5: The method of Clause 4, wherein the at least one criterion comprises at least one of a location of the UE or a round trip time (RTT) between the UE and the NTBS.

Clause 6: The method of any one of Clauses 4-5, further comprising: selecting the four-step RACH procedure to transmit the SDT indication message; transmitting, to the NTBS, a RACH preamble in a first message of the four-step RACH procedure; receiving, from the NTBS in response to the RACH preamble, a second message of the four-step RACH procedure indicating the TA for the UE to use for communicating with the NTBS; transmitting, to the NTBS in response to receiving the second message of the four-step RACH procedure, a third message of the four-step RACH procedure, wherein transmitting the SDT indication message comprises transmitting the SDT indication message in the in the third message of the four-step RACH procedure; and receiving, in response to the SDT indication in the third message of the four-step RACH procedure, a fourth message of the four-step RACH procedure, wherein receiving the resource indication message comprises receiving the resource indication message in the fourth message of the four-step RACH procedure.

Clause 7: The method of any one of Clauses 4-5, further comprising: selecting the two-step RACH procedure to transmit the SDT indication message; transmitting, to the NTBS, a first message of the two-step RACH procedure, wherein the first message of the two-step RACH procedure includes a RACH preamble portion and a physical uplink shared channel (PUSCH) payload portion, and wherein transmitting the SDT indication message comprises transmitting the SDT indication message in the PUSCH payload portion of the first message of the two-step RACH procedure; and receiving, from the NTBS in response to the first message of the two-step RACH procedure, a second message of the two-step RACH procedure, wherein receiving the resource indication message comprises receiving the resource indication message in the second message of the two-step RACH procedure.

Clause 8: The method of Clause 7, wherein: the PUSCH portion of the first message of the two-step RACH procedure provides an indication of an estimated TA for communicating with the NTBS, and the second message of the two-step RACH procedure further includes an indication of an offset to apply to the estimated TA for communicating with the NTBS.

Clause 9: The method of Clause 8, further comprising determining the estimated TA based on a global navigation satellite system (GNSS) capability of the UE.

Clause 10: The method of any one of Clauses 1-9, further comprising: transmitting, when the UE is operating in the inactive mode, a radio resource control (RRC) message to the NTBS, wherein the RRC message includes a resume identifier (ID) associated with the UE and an authentication token associated with the UE; and receiving, after transmitting the RRC request message and the SDT, an RRC release message terminating the SDT.

Clause 11: The method of any one of Clauses 1-9, wherein transmitting the user data in the SDT comprises transmitting the user data in the SDT together with an identifier of the UE and security information associated with the UE.

Clause 12: The method of any one of Clauses 1-11, further comprising transmitting, to the NTBS while the UE is in the idle or inactive mode, at least one of: a buffer status report (BSR), indicating a buffer status of the UE associated with newly-arrived user data for transmission via a data radio bearer (DRB) associated with the SDT or other DRBs; or a power headroom report (PHR), indicating a remaining power level of the UE for uplink transmissions.

Clause 13: The method of any one of clauses 1-12, wherein resources for performing a random access channel (RACH) procedure for initiating the SDT are distinct from resources for performing a RACH procedure for non-SDT communication.

Clause 14. The method of clause 13, wherein the resources for performing the RACH procedure for initiating the SDT include at least one of: random access occasions (ROs) that are distinct from ROs for non-SDT communication; or RACH preambles that are distinct from RACH preambles for non-SDT communication.

Clause 15: A method for wireless communication by a user equipment (UE), comprising: receiving, from a first non-terrestrial base station (NTBS) in a non-terrestrial network (NTN), a first message including: a first indication of a set of resources for communicating user data in a small data transfer (SDT) while the UE is in an idle or inactive mode; and a second indication of a dedicated random access channel (RACH) preamble for initiating the SDT; and communicating the user data in the SDT while the UE is in the idle or inactive mode via the set of resources indicated in the first message.

Clause 16: The method of Clause 15, wherein receiving the first message comprises receiving the first message while the UE is in a connected mode and the first message comprises a radio resource control (RRC) release message.

Clause 17: The method of Clause 16, further comprising transmitting, to the first NTBS while the UE is in the connected mode, an SDT indication message, requesting the dedicated RACH preamble and the set of resources for communicating the user data in the SDT.

Clause 18: The method of Clause 17, wherein communicating the user data in the SDT comprises transmitting the user data in the SDT to the first NTBS.

Clause 19: The method of Clause 15, wherein receiving the first message comprises receiving the first message in a paging message from the first NTBS.

Clause 20: The method of claim 19, wherein: the first message further includes a mobile terminating (MT)-SDT indication, indicating that the user data comprises MT data, and communicating the user data in the SDT comprises receiving, based on the MT-SDT indication, the MT data in the SDT from the first NTBS.

Clause 21: The method of any one of Clauses 15-20, further comprising performing a RACH procedure with the NTBS for initiating the SDT, wherein performing the RACH procedure comprises: transmitting, to the first NTBS, the dedicated RACH preamble to initiate the SDT; and receiving, based on the dedicated RACH preamble, a RACH response message indicating a time advance (TA) for communicating the user data in the SDT, wherein communicating the user data in the SDT comprises communicating the user data in the SDT with the first NTBS based on the TA received in the RACH response message.

Clause 22: The method of Clause 21, wherein resources for performing the RACH procedure for initiating the SDT are distinct from resources for performing a RACH procedure for non-SDT communication.

Clause 23: The method of Clause 22, wherein the resources for performing the RACH procedure for initiating the SDT include at least one of: random access occasions (ROs) that are distinct from ROs for non-SDT communication; or RACH preambles, including the dedicated RACH preamble, that are distinct from RACH preambles for non-SDT communication.

Clause 24: The method of Clause 15, wherein: the first message comprises a radio resource control (RRC) reconfiguration message, instructing the UE to handover to a second NTBS from the first NTBS, and the set of resources for communicating the user data in the SDT and the dedicated RACH preamble are associated with the second NTBS; and communicating the user data in the SDT comprises communicating the user data in the SDT with the second NTBS after handing over to the second NTBS.

Clause 25: The method of any one of Clauses 15-24, further comprising transmitting, to the first NTBS while the UE is in the idle or inactive mode, at least one of: a buffer status report (BSR), indicating a buffer status of the UE associated with newly-arrived user data for transmission via a data radio bearer (DBR) associated with the SDT or other DBRs; or a power headroom report (PHR), indicating a remaining power level of the UE for uplink transmissions.

Clause 26: A method for wireless communication by a non-terrestrial base station (NTBS), comprising: receiving, from a user equipment (UE) in a non-terrestrial network (NTN), a small data transfer (SDT) indication message including a first indication that the UE has user data to transmit in an SDT while the UE is in an idle or inactive mode; transmitting, to the UE in response to the SDT indication message, a resource indication message including an indication of a set of resources for transmitting the user data in the SDT while the UE is in the idle or inactive mode; and receiving the user data in the SDT from the UE while the UE is in the idle or inactive mode via the set of resources indicated in the resource indication message.

Clause 27: The method of Clause 26, wherein the SDT indication message further includes: a second indication of whether there will be additional user data for communication subsequent to the transmission of the user data in the SDT, a third indication of a traffic profile associated with the SDT, indicating whether the SDT comprises one-shot traffic or multiple-shot traffic, and a traffic periodicity and amount of user data associated with each shot of the one-shot traffic or multiple-shot traffic.

Clause 28: The method of any one of Clauses 26-27, wherein the resource indication message further includes: an indication of a common or UE-specific search space associated with the UE, a UE-specific radio temporary identifier (RNTI) associated with the UE, and information for configuring a timer associated with a time advance (TA) for communicating with the NTBS, wherein expiration of the timer indicates that the TA and the set of resources for transmitting the SDT are invalid.

Clause 29: The method of any one of Clauses 26-28, further comprising: receiving, from the UE, a random access response (RACH) preamble in a first message of a four-step RACH procedure; transmitting, to the UE in response to the RACH preamble, a second message of the four-step RACH procedure indicating the TA for the UE to use for communicating with the NTBS; receiving, from the UE in response to receiving the second message of the four-step RACH procedure, a third message of the four-step RACH procedure, wherein receiving the SDT indication message comprises receiving the SDT indication message in the in the third message of the four-step RACH procedure; and transmitting, in response to the SDT indication in the third message of the four-step RACH procedure, a fourth message of the four-step RACH procedure, wherein transmitting the resource indication message comprises transmitting the resource indication message in the fourth message of the four-step RACH procedure.

Clause 30 The method of any one of Clauses 26-28, further comprising: receiving, from the UE, a first message of a two-step random access channel (RACH) procedure, wherein the first message of the two-step RACH procedure includes a RACH preamble portion and a physical uplink shared channel (PUSCH) payload portion, and wherein receiving the SDT indication message comprises receiving the SDT indication message in the PUSCH payload portion of the first message of the two-step RACH procedure; and transmitting, to the UE in response to the first message of the two-step RACH procedure, a second message of the two-step RACH procedure, wherein transmitting the resource indication message comprises transmitting the resource indication message in the second message of the two-step RACH procedure.

Clause 31: The method of Clause 30, wherein: the PUSCH portion of the first message of the two-step RACH procedure provides an indication of an estimated TA for communicating with the NTBS, and the second message of the two-step RACH procedure further includes an indication of an offset to apply to the estimated TA for communicating with the NTBS.

Clause 32: The method of any one of Clauses 26-31, further comprising: receiving, when the UE is operating in the inactive mode, a radio resource control (RRC) message from the UE, wherein the RRC message includes a resume identifier (ID) associated with the UE and an authentication token associated with the UE; and transmitting, after receiving the RRC request message and the user data in the SDT, an RRC release message terminating the SDT.

Clause 33: The method of any one of Clauses 26-31, wherein receiving the user data in the SDT comprises receiving the user data in the SDT together with an identifier of the UE and security information associated with the UE.

Clause 34: The method of any one of Clauses 26-33, further comprising receiving, from the UE while the UE is in the idle or inactive mode, at least one of: a buffer status report (BSR), indicating a buffer status of the UE associated with newly-arrived user data for transmission via a data radio bearer (DRB) associated with the SDT or other DRBs; or a power headroom report (PHR), indicating a remaining power level of the UE for uplink transmissions.

Clause 35: The method of any one of clauses 26-34, wherein resources for performing a random access channel (RACH) procedure for initiating the SDT are distinct from resources for performing a RACH procedure for non-SDT communication.

Clause 36. The method of clause 35, wherein the resources for performing the RACH procedure for initiating the SDT include at least one of: random access occasions (ROs) that are distinct from ROs for non-SDT communication; or RACH preambles that are distinct from RACH preambles for non-SDT communication.

Clause 37: A method for wireless communication by a first non-terrestrial base station (NTBS), comprising: transmitting, to a user equipment (UE) in a non-terrestrial network (NTN), a first message including: a first indication of a set of resources for communicating user data in a small data transfer (SDT) while the UE is in an idle or inactive mode; and a second indication of a dedicated random access channel (RACH) preamble for initiating the SDT.

Clause 38: The method of Clause 37, further comprising communicating the user data in the SDT while the UE is in the idle or inactive mode via the set of resources indicated in the first message.

Clause 39: The method of Clause 38, wherein transmitting the first message comprises transmitting the first message while the UE is in a connected mode and the first message comprises a radio resource control (RRC) release message.

Clause 40: The method of Clause 39, further comprising receiving, from the UE while the UE is in the connected mode, an SDT indication message, requesting the dedicated RACH preamble and the set of resources for communicating the user data in the SDT.

Clause 41: The method of Clause 40, wherein communicating the user data in the SDT comprises receiving the user data in the SDT from the UE.

Clause 42: The method of Clause 38, wherein transmitting the first message comprises transmitting the first message in a paging message to the UE.

Clause 43: The method of claim 42, wherein: the first message further includes a mobile terminating (MT)-SDT indication, indicating that the user data comprises MT data, and communicating the user data in the SDT comprises transmitting, based on the MT-SDT indication, the MT data in the SDT to the UE.

Clause 44: The method of any one of Clauses 38-43, further comprising performing a RACH procedure with the UE for initiating the SDT, wherein performing the RACH procedure comprises: receiving, from the UE, the dedicated RACH preamble to initiate the SDT; and transmitting, based on the dedicated RACH preamble, a RACH response message indicating a time advance (TA) for communicating the user data in the SDT, wherein communicating the user data in the SDT comprises communicating the user data in the SDT with the UE based on the TA transmitted in the RACH response message.

Clause 45: The method of Clause 44, wherein resources for performing the RACH procedure for initiating the SDT are distinct from resources for performing a RACH procedure for non-SDT communication.

Clause 46: The method of Clause 45, wherein the resources for performing the RACH procedure for initiating the SDT include at least one of: random access occasions (ROs) that are distinct from ROs for non-SDT communication; or RACH preambles, including the dedicated RACH preamble, that are distinct from RACH preambles for non-SDT communication.

Clause 47: The method of any one of Clauses 37-46, wherein: the first message comprises a radio resource control (RRC) reconfiguration message, instructing the UE to handover to a second NTBS from the first NTBS, and the set of resources for communicating the user data in the SDT and the dedicated RACH preamble are associated with the second NTBS.

Clause 48: The method of any one of Clauses 37-47, further comprising receiving, from the UE while the UE is in the idle or inactive mode, at least one of: a buffer status report (BSR), indicating a buffer status of the UE associated with newly-arrived user data for transmission via a data radio bearer (DBR) associated with the SDT or other DBRs; or a power headroom report (PHR), indicating a remaining power level of the UE for uplink transmissions.

Clause 49: An apparatus, comprising: a memory comprising executable instructions; one or more processors configured to execute the executable instructions and cause the apparatus to perform a method in accordance with any one of Clauses 1-48.

Clause 50: An apparatus, comprising means for performing a method in accordance with any one of Clauses 1-48.

Clause 51: A non-transitory computer-readable medium comprising executable instructions that, when executed by one or more processors of an apparatus, cause the apparatus to perform a method in accordance with any one of Clauses 1-48.

Clause 52: A computer program product embodied on a computer-readable storage medium comprising code for performing a method in accordance with any one of Clauses 1-48.

### Additional Wireless Communication Network Considerations

The techniques and methods described herein may be used for various wireless communications networks (or wireless wide area network (WWAN)) and radio access technologies (RATs). While aspects may be described herein using terminology commonly associated with 3G, 4G, and/or 5G (e.g., 5G new radio (NR)) wireless technologies, aspects of the present disclosure may likewise be applicable to other communication systems and standards not explicitly mentioned herein.

5G wireless communication networks may support various advanced wireless communication services, such as enhanced mobile broadband (eMBB), millimeter wave (mmWave), machine type communications (MTC), and/or mission critical targeting ultra-reliable, low-latency communications (URLLC). These services, and others, may include latency and reliability requirements.

Returning to FIG. 1, various aspects of the present disclosure may be performed within the example wireless communication network 100.

In 3GPP, the term “cell” can refer to a coverage area of a NodeB and/or a narrowband subsystem serving this coverage area, depending on the context in which the term is used. In NR systems, the term “cell” and BS, next generation NodeB (gNB or gNodeB), access point (AP), distributed unit (DU), carrier, or transmission reception point may be used interchangeably. A BS may provide communication coverage for a macro cell, a pico cell, a femto cell, and/or other types of cells.

A macro cell may generally cover a relatively large geographic area (e.g., several kilometers in radius) and may allow unrestricted access by UEs with service subscription. A pico cell may cover a relatively small geographic area (e.g., a sports stadium) and may allow unrestricted access by UEs with service subscription. A femto cell may cover a relatively small geographic area (e.g., a home) and may allow restricted access by UEs having an association with the femto cell (e.g., UEs in a Closed Subscriber Group (CSG) and UEs for users in the home). A BS for a macro cell may be referred to as a macro BS. A BS for a pico cell may be referred to as a pico BS. A BS for a femto cell may be referred to as a femto BS, home BS, or a home NodeB.

Base stations 102 configured for 4G LTE (collectively referred to as Evolved Universal Mobile Telecommunications System (UMTS) Terrestrial Radio Access Network (E-UTRAN)) may interface with the EPC 160 through first backhaul links 132 (e.g., an S1 interface). Base stations 102 configured for 5G (e.g., 5G NR or Next Generation RAN (NG-RAN)) may interface with 5GC 190 through second backhaul links 184. Base stations 102 may communicate directly or indirectly (e.g., through the EPC 160 or 5GC 190) with each other over third backhaul links 134 (e.g., X2 interface). Third backhaul links 134 may generally be wired or wireless.

Small cell 102′ may operate in a licensed and/or an unlicensed frequency spectrum. When operating in an unlicensed frequency spectrum, the small cell 102′ may employ NR and use the same 5 GHz unlicensed frequency spectrum as used by the Wi-Fi AP 150. Small cell 102′, employing NR in an unlicensed frequency spectrum, may boost coverage to and/or increase capacity of the access network.

Some base stations, such as gNB 180 may operate in a traditional sub-6 GHz spectrum, in millimeter wave (mmWave) frequencies, and/or near mmWave frequencies in communication with the UE 104. When the gNB 180 operates in mmWave or near mmWave frequencies, the gNB 180 may be referred to as an mmWave base station.

The communication links 120 between base stations 102 and, for example, UEs 104, may be through one or more carriers. For example, base stations 102 and UEs 104 may use spectrum up to Y MHz (e.g., 5, 10, 15, 20, 100, 400, and other MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Wireless communication network 100 further includes a Wi-Fi access point (AP) 150 in communication with Wi-Fi stations (STAs) 152 via communication links 154 in, for example, a 2.4 GHz and/or 5 GHz unlicensed frequency spectrum. When communicating in an unlicensed frequency spectrum, the STAs 152/AP 150 may perform a clear channel assessment (CCA) prior to communicating in order to determine whether the channel is available.

Certain UEs 104 may communicate with each other using device-to-device (D2D) communication link 158. The D2D communication link 158 may use the DL/UL WWAN spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, FlashLinQ, WiMedia, Bluetooth, ZigBee, Wi-Fi based on the IEEE 802.11 standard, 4G (e.g., LTE), or 5G (e.g., NR), to name a few options.

In some cases, communication between UEs 104 and 5GC 190 may be facilitated by a non-terrestrial (NT) device, such as satellite 140. Satellite 140 may communicate with BSs 102/180 and UEs 104. In some cases, satellite 140 may have a backhaul link 184 to the 5GC 190 or may interface with the 5GC via BS 102. Satellite 140 may be any suitable type of communication satellite configured to relay communications between different end nodes in a wireless communication network. Satellite 140 may be an example of a space satellite, a balloon, a dirigible, an airplane, a drone, an unmanned aerial vehicle, and/or the like. In some examples, the satellite 140 may be in a geosynchronous or geostationary Earth orbit, a low Earth orbit or a medium Earth orbit. Satellite 140 may be a multi-beam satellite configured to provide service for multiple service beam coverage areas in a predefined geographical service area. The satellite 140 may be any distance away from the surface of the Earth.

In some cases, a cell 110 may be provided or established by a satellite 140 as part of a non-terrestrial network. Satellite 140 may, in some cases, perform the functions of a BS 102, act as a bent-pipe satellite, or may act as a regenerative satellite, or a combination thereof. In other cases, satellite 140 may be an example of a smart satellite, or a satellite with intelligence. For example, a smart satellite may be configured to perform more functions than a regenerative satellite (e.g., may be configured to perform particular algorithms beyond those used in regenerative satellites, to be reprogrammed, etc.). A bent-pipe transponder or satellite may be configured to receive signals from ground stations and transmit/relay those signals to different ground stations. In some cases, a bent-pipe transponder or satellite may amplify signals or shift from uplink frequencies to downlink frequencies. For example, a bent-pipe satellite (e.g., satellite 140) may receive a signal from a BS 102 and may relay the signal to a UE 104 or another BS 102, or vice-versa. A regenerative transponder or satellite may be configured to relay signals like the bent-pipe transponder or satellite, but may also use on-board processing to perform other functions. Examples of these other functions may include demodulating a received signal, decoding a received signal, re-encoding a signal to be transmitted, or modulating the signal to be transmitted, or a combination thereof.

EPC 160 may include a Mobility Management Entity (MME) 162, other MMEs 164, a Serving Gateway 166, a Multimedia Broadcast Multicast Service (MBMS) Gateway 168, a Broadcast Multicast Service Center (BM-SC) 170, and a Packet Data Network (PDN) Gateway 172. MME 162 may be in communication with a Home Subscriber Server (HSS) 174. MME 162 is the control node that processes the signaling between the UEs 104 and the EPC 160. Generally, MME 162 provides bearer and connection management.

Generally, user Internet protocol (IP) packets are transferred through Serving Gateway 166, which itself is connected to PDN Gateway 172. PDN Gateway 172 provides UE IP address allocation as well as other functions. PDN Gateway 172 and the BM-SC 170 are connected to the IP Services 176, which may include, for example, the Internet, an intranet, an IP Multimedia Subsystem (IMS), a PS Streaming Service, and/or other IP services.

BM-SC 170 may provide functions for MBMS user service provisioning and delivery. BM-SC 170 may serve as an entry point for content provider MBMS transmission, may be used to authorize and initiate MBMS Bearer Services within a public land mobile network (PLMN), and may be used to schedule MBMS transmissions. MBMS Gateway 168 may be used to distribute MBMS traffic to the base stations 102 belonging to a Multicast Broadcast Single Frequency Network (MBSFN) area broadcasting a particular service, and may be responsible for session management (start/stop) and for collecting eMBMS related charging information.

5GC 190 may include an Access and Mobility Management Function (AMF) 192, other AMFs 193, a Session Management Function (SMF) 194, and a User Plane Function (UPF) 195. AMF 192 may be in communication with a Unified Data Management (UDM) 196.

AMF 192 is generally the control node that processes the signaling between UEs 104 and 5GC 190. Generally, AMF 192 provides QoS flow and session management.

All user Internet protocol (IP) packets are transferred through UPF 195, which is connected to the IP Services 197, and which provides UE IP address allocation as well as other functions for 5GC 190. IP Services 197 may include, for example, the Internet, an intranet, an IP Multimedia Subsystem (IMS), a PS Streaming Service, and/or other IP services.

Returning to FIG. 2, various example components of BS 102 and UE 104 (e.g., the wireless communication network 100 of FIG. 1) are depicted, which may be used to implement aspects of the present disclosure.

At BS 102, a transmit processor 220 may receive data from a data source 212 and control information from a controller/processor 240. The control information may be for the physical broadcast channel (PBCH), physical control format indicator channel (PCFICH), physical hybrid ARQ indicator channel (PHICH), physical downlink control channel (PDCCH), group common PDCCH (GC PDCCH), and others. The data may be for the physical downlink shared channel (PDSCH), in some examples.

A medium access control (MAC)-control element (MAC-CE) is a MAC layer communication structure that may be used for control command exchange between wireless nodes. The MAC-CE may be carried in a shared channel such as a physical downlink shared channel (PDSCH), a physical uplink shared channel (PUSCH), or a physical sidelink shared channel (PSSCH).

Processor 220 may process (e.g., encode and symbol map) the data and control information to obtain data symbols and control symbols, respectively. Transmit processor 220 may also generate reference symbols, such as for the primary synchronization signal (PSS), secondary synchronization signal (SSS), PBCH demodulation reference signal (DMRS), and channel state information reference signal (CSI-RS).

Transmit (TX) multiple-input multiple-output (MIMO) processor 230 may perform spatial processing (e.g., precoding) on the data symbols, the control symbols, and/or the reference symbols, if applicable, and may provide output symbol streams to the modulators (MODs) in transceivers 232a-232t. Each modulator in transceivers 232a-232t may process a respective output symbol stream (e.g., for OFDM) to obtain an output sample stream. Each modulator may further process (e.g., convert to analog, amplify, filter, and upconvert) the output sample stream to obtain a downlink signal. Downlink signals from the modulators in transceivers 232a-232t may be transmitted via the antennas 234a-234t, respectively.

At UE 104, antennas 252a-252r may receive the downlink signals from the BS 102 and may provide received signals to the demodulators (DEMODs) in transceivers 254a-254r, respectively. Each demodulator in transceivers 254a-254r may condition (e.g., filter, amplify, downconvert, and digitize) a respective received signal to obtain input samples. Each demodulator may further process the input samples (e.g., for OFDM) to obtain received symbols.

MIMO detector 256 may obtain received symbols from all the demodulators in transceivers 254a-254r, perform MIMO detection on the received symbols if applicable, and provide detected symbols. Receive processor 258 may process (e.g., demodulate, deinterleave, and decode) the detected symbols, provide decoded data for the UE 104 to a data sink 260, and provide decoded control information to a controller/processor 280.

On the uplink, at UE 104, transmit processor 264 may receive and process data (e.g., for the physical uplink shared channel (PUSCH)) from a data source 262 and control information (e.g., for the physical uplink control channel (PUCCH) from the controller/processor 280. Transmit processor 264 may also generate reference symbols for a reference signal (e.g., for the sounding reference signal (SRS)). The symbols from the transmit processor 264 may be precoded by a TX MIMO processor 266 if applicable, further processed by the modulators in transceivers 254a-254r (e.g., for SC-FDM), and transmitted to BS 102.

At BS 102, the uplink signals from UE 104 may be received by antennas 234a-t, processed by the demodulators in transceivers 232a-232t, detected by a MIMO detector 236 if applicable, and further processed by a receive processor 238 to obtain decoded data and control information sent by UE 104. Receive processor 238 may provide the decoded data to a data sink 239 and the decoded control information to the controller/processor 240.

Memories 242 and 282 may store data and program codes for BS 102 and UE 104, respectively.

Scheduler 244 may schedule UEs for data transmission on the downlink and/or uplink.

5G may utilize orthogonal frequency division multiplexing (OFDM) with a cyclic prefix (CP) on the uplink and downlink. 5G may also support half-duplex operation using time division duplexing (TDD). OFDM and single-carrier frequency division multiplexing (SC-FDM) partition the system bandwidth into multiple orthogonal subcarriers, which are also commonly referred to as tones and bins. Each subcarrier may be modulated with data. Modulation symbols may be sent in the frequency domain with OFDM and in the time domain with SC-FDM. The spacing between adjacent subcarriers may be fixed, and the total number of subcarriers may be dependent on the system bandwidth. The minimum resource allocation, called a resource block (RB), may be 12 consecutive subcarriers in some examples. The system bandwidth may also be partitioned into subbands. For example, a subband may cover multiple RBs. NR may support a base subcarrier spacing (SCS) of 15 KHz and other SCS may be defined with respect to the base SCS (e.g., 30 kHz, 60 kHz, 120 kHz, 240 kHz, and others).

As above, FIGS. 3A-3D depict various example aspects of data structures for a wireless communication network, such as wireless communication network 100 of FIG. 1.

In various aspects, the 5G frame structure may be frequency division duplex (FDD), in which for a particular set of subcarriers (carrier system bandwidth), subframes within the set of subcarriers are dedicated for either DL or UL. 5G frame structures may also be time division duplex (TDD), in which for a particular set of subcarriers (carrier system bandwidth), subframes within the set of subcarriers are dedicated for both DL and UL. In the examples provided by FIGS. 3A and 3C, the 5G frame structure is assumed to be TDD, with subframe 4 being configured with slot format 28 (with mostly DL), where D is DL, U is UL, and X is flexible for use between DL/UL, and subframe 3 being configured with slot format 34 (with mostly UL). While subframes 3, 4 are shown with slot formats 34, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description below applies also to a 5G frame structure that is TDD.

Other wireless communication technologies may have a different frame structure and/or different channels. A frame (10 ms) may be divided into 10 equally sized subframes (1 ms). Each subframe may include one or more time slots. Subframes may also include mini-slots, which may include 7, 4, or 2 symbols. In some examples, each slot may include 7 or 14 symbols, depending on the slot configuration.

For example, for slot configuration 0, each slot may include 14 symbols, and for slot configuration 1, each slot may include 7 symbols. The symbols on DL may be cyclic prefix (CP) OFDM (CP-OFDM) symbols. The symbols on UL may be CP-OFDM symbols (for high throughput scenarios) or discrete Fourier transform (DFT) spread OFDM (DFT-s-OFDM) symbols (also referred to as single carrier frequency-division multiple access (SC-FDMA) symbols) (for power limited scenarios; limited to a single stream transmission).

The number of slots within a subframe is based on the slot configuration and the numerology. For slot configuration 0, different numerologies (p) 0 to 5 allow for 1, 2, 4, 8, 16, and 32 slots, respectively, per subframe. For slot configuration 1, different numerologies 0 to 2 allow for 2, 4, and 8 slots, respectively, per subframe. Accordingly, for slot configuration 0 and numerology μ, there are 14 symbols/slot and 2μ slots/subframe. The subcarrier spacing and symbol length/duration are a function of the numerology. The subcarrier spacing may be equal to 2^{μ}×15 kHz, where is the numerology 0 to 5. As such, the numerology μ=0 has a subcarrier spacing of 15 kHz and the numerology μ=5 has a subcarrier spacing of 480 kHz. The symbol length/duration is inversely related to the subcarrier spacing. FIGS. 3A-3D provide an example of slot configuration 0 with 14 symbols per slot and numerology μ=2 with 4 slots per subframe. The slot duration is 0.25 ms, the subcarrier spacing is 60 kHz, and the symbol duration is approximately 16.67 μs.

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 3A, some of the REs carry reference (pilot) signals (RS) for a UE (e.g., UE 104 of FIGS. 1 and 2). The RS may include demodulation RS (DM-RS) (indicated as Rx for one particular configuration, where 100× is the port number, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 3B illustrates an example of various DL channels within a subframe of a frame. The physical downlink control channel (PDCCH) carries DCI within one or more control channel elements (CCEs), each CCE including nine RE groups (REGs), each REG including four consecutive REs in an OFDM symbol.

A primary synchronization signal (PSS) may be within symbol 2 of particular subframes of a frame. The PSS is used by a UE (e.g., 104 of FIGS. 1 and 2) to determine subframe/symbol timing and a physical layer identity.

A secondary synchronization signal (SSS) may be within symbol 4 of particular subframes of a frame. The SSS is used by a UE to determine a physical layer cell identity group number and radio frame timing.

Based on the physical layer identity and the physical layer cell identity group number, the UE can determine a physical cell identifier (PCI). Based on the PCI, the UE can determine the locations of the aforementioned DM-RS. The physical broadcast channel (PBCH), which carries a master information block (MIB), may be logically grouped with the PSS and SSS to form a synchronization signal (SS)/PBCH block. The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 3C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 3D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and HARQ ACK/NACK feedback. The PUSCH carries data, and may additionally be used to carry a buffer status report (BSR), a power headroom report (PHR), and/or UCI.

### ADDITIONAL CONSIDERATIONS

The preceding description provides examples of communicating user data in a small data transfer (SDT) in communication systems, such as a non-terrestrial network (NTN). The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the generic principles defined herein may be applied to other aspects. For example, changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

The techniques described herein may be used for various wireless communication technologies, such as 5G (e.g., 5G NR), 3GPP Long Term Evolution (LTE), LTE-Advanced (LTE-A), code division multiple access (CDMA), time division multiple access (TDMA), frequency division multiple access (FDMA), orthogonal frequency division multiple access (OFDMA), single-carrier frequency division multiple access (SC-FDMA), time division synchronous code division multiple access (TD-SCDMA), and other networks. The terms “network” and “system” are often used interchangeably. A CDMA network may implement a radio technology such as Universal Terrestrial Radio Access (UTRA), cdma2000, and others. UTRA includes Wideband CDMA (WCDMA) and other variants of CDMA. cdma2000 covers IS-2000, IS-95 and IS-856 standards. A TDMA network may implement a radio technology such as Global System for Mobile Communications (GSM). An OFDMA network may implement a radio technology such as NR (e.g. 5G RA), Evolved UTRA (E-UTRA), Ultra Mobile Broadband (UMB), IEEE 802.11 (Wi-Fi), IEEE 802.16 (WiMAX), IEEE 802.20, Flash-OFDMA, and others. UTRA and E-UTRA are part of Universal Mobile Telecommunication System (UMTS). LTE and LTE-A are releases of UMTS that use E-UTRA. UTRA, E-UTRA, UMTS, LTE, LTE-A and GSM are described in documents from an organization named “3rd Generation Partnership Project” (3GPP). cdma2000 and UMB are described in documents from an organization named “3rd Generation Partnership Project 2” (3GPP2). NR is an emerging wireless communications technology under development.

The various illustrative logical blocks, modules and circuits described in connection with the present disclosure may be implemented or performed with a general purpose processor, a DSP, an ASIC, a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, a system on a chip (SoC), or any other such configuration.

If implemented in hardware, an example hardware configuration may comprise a processing system in a wireless node. The processing system may be implemented with a bus architecture. The bus may include any number of interconnecting buses and bridges depending on the specific application of the processing system and the overall design constraints. The bus may link together various circuits including a processor, machine-readable media, and a bus interface. The bus interface may be used to connect a network adapter, among other things, to the processing system via the bus. The network adapter may be used to implement the signal processing functions of the PHY layer. In the case of a user equipment (see FIG. 1), a user interface (e.g., keypad, display, mouse, joystick, touchscreen, biometric sensor, proximity sensor, light emitting element, and others) may also be connected to the bus. The bus may also link various other circuits such as timing sources, peripherals, voltage regulators, power management circuits, and the like, which are well known in the art, and therefore, will not be described any further. The processor may be implemented with one or more general-purpose and/or special-purpose processors. Examples include microprocessors, microcontrollers, DSP processors, and other circuitry that can execute software. Those skilled in the art will recognize how best to implement the described functionality for the processing system depending on the particular application and the overall design constraints imposed on the overall system.

If implemented in software, the functions may be stored or transmitted over as one or more instructions or code on a computer readable medium. Software shall be construed broadly to mean instructions, data, or any combination thereof, whether referred to as software, firmware, middleware, microcode, hardware description language, or otherwise. Computer-readable media include both computer storage media and communication media including any medium that facilitates transfer of a computer program from one place to another. The processor may be responsible for managing the bus and general processing, including the execution of software modules stored on the machine-readable storage media. A computer-readable storage medium may be coupled to a processor such that the processor can read information from, and write information to, the storage medium. In the alternative, the storage medium may be integral to the processor. By way of example, the machine-readable media may include a transmission line, a carrier wave modulated by data, and/or a computer readable storage medium with instructions stored thereon separate from the wireless node, all of which may be accessed by the processor through the bus interface. Alternatively, or in addition, the machine-readable media, or any portion thereof, may be integrated into the processor, such as the case may be with cache and/or general register files. Examples of machine-readable storage media may include, by way of example, RAM (Random Access Memory), flash memory, ROM (Read Only Memory), PROM (Programmable Read-Only Memory), EPROM (Erasable Programmable Read-Only Memory), EEPROM (Electrically Erasable Programmable Read-Only Memory), registers, magnetic disks, optical disks, hard drives, or any other suitable storage medium, or any combination thereof. The machine-readable media may be embodied in a computer-program product.

A software module may comprise a single instruction, or many instructions, and may be distributed over several different code segments, among different programs, and across multiple storage media. The computer-readable media may comprise a number of software modules. The software modules include instructions that, when executed by an apparatus such as a processor, cause the processing system to perform various functions. The software modules may include a transmission module and a receiving module. Each software module may reside in a single storage device or be distributed across multiple storage devices. By way of example, a software module may be loaded into RAM from a hard drive when a triggering event occurs. During execution of the software module, the processor may load some of the instructions into cache to increase access speed. One or more cache lines may then be loaded into a general register file for execution by the processor. When referring to the functionality of a software module below, it will be understood that such functionality is implemented by the processor when executing instructions from that software module.

As used herein, the word “exemplary” means “serving as an example, instance, or illustration.” Any aspect described herein as “exemplary” is not necessarily to be construed as preferred or advantageous over other aspects.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

The methods disclosed herein comprise one or more steps or actions for achieving the methods. The method steps and/or actions may be interchanged with one another without departing from the scope of the claims. In other words, unless a specific order of steps or actions is specified, the order and/or use of specific steps and/or actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in figures, those operations may have corresponding counterpart means-plus-function components with similar numbering.

The following claims are not intended to be limited to the aspects shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112(f) unless the element is expressly recited using the phrase “means for” or, in the case of a method claim, the element is recited using the phrase “step for.” All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

What is claimed is:

1. A method for wireless communication by a user equipment (UE), comprising:
transmitting, to a non-terrestrial base station (NTBS) in a non-terrestrial network (NTN), a small data transfer (SDT) indication message including a first indication that the UE has user data to transmit in an SDT while the UE is in an idle or inactive mode;
receiving, from the NTBS in response to the SDT indication message, a resource indication message including an indication of a set of resources for transmitting the user data while the UE is in the idle or inactive mode; and
transmitting the user data in the SDT to the NTBS while the UE is in the idle or inactive mode via the set of resources indicated in the resource indication message.

2. The method of claim 1, wherein the SDT indication message further includes:
a second indication of whether there will be additional user data for communication subsequent to the transmission of the user data in the SDT,
a third indication of a traffic profile associated with the SDT, indicating whether the SDT comprises one-shot traffic or multiple-shot traffic, and
a traffic periodicity and amount of user data associated with each shot of the one-shot traffic or multiple-shot traffic.

3. The method of claim 1, wherein the resource indication message further includes:
an indication of a common or UE-specific search space associated with the UE,
a UE-specific radio temporary identifier (RNTI) associated with the UE, and
information for configuring a timer associated with a time advance (TA) for communicating with the NTBS, wherein expiration of the timer indicates that the TA and the set of resources for transmitting the user data in the SDT are invalid.

4. The method of claim 1, further comprising selecting either the two-step RACH procedure to transmit the SDT indication message or the four-step RACH procedure to transmit the SDT indication message based on at least one criterion.

5. The method of claim 4, wherein the at least one criterion comprises at least one of a location of the UE or a round trip time (RTT) between the UE and the NTBS.

6. The method of claim 4, further comprising:
selecting the four-step RACH procedure to transmit the SDT indication message;
transmitting, to the NTBS, a RACH preamble in a first message of the four-step RACH procedure;
receiving, from the NTBS in response to the RACH preamble, a second message of the four-step RACH procedure indicating the TA for the UE to use for communicating with the NTBS;
transmitting, to the NTBS in response to receiving the second message of the four-step RACH procedure, a third message of the four-step RACH procedure, wherein transmitting the SDT indication message comprises transmitting the SDT indication message in the in the third message of the four-step RACH procedure; and
receiving, in response to the SDT indication in the third message of the four-step RACH procedure, a fourth message of the four-step RACH procedure, wherein receiving the resource indication message comprises receiving the resource indication message in the fourth message of the four-step RACH procedure.

7. The method of claim 4, further comprising:
selecting the two-step RACH procedure to transmit the SDT indication message;
transmitting, to the NTBS, a first message of the two-step RACH procedure, wherein the first message of the two-step RACH procedure includes a RACH preamble portion and a physical uplink shared channel (PUSCH) payload portion, and wherein transmitting the SDT indication message comprises transmitting the SDT indication message in the PUSCH payload portion of the first message of the two-step RACH procedure; and
receiving, from the NTBS in response to the first message of the two-step RACH procedure, a second message of the two-step RACH procedure, wherein receiving the resource indication message comprises receiving the resource indication message in the second message of the two-step RACH procedure.

8. The method of claim 7, wherein:
the PUSCH portion of the first message of the two-step RACH procedure provides an indication of an estimated TA for communicating with the NTBS, and
the second message of the two-step RACH procedure further includes an indication of an offset to apply to the estimated TA for communicating with the NTBS.

9. The method of claim 1, further comprising:
transmitting, when the UE is operating in the inactive mode, a radio resource control (RRC) message to the NTBS, wherein the RRC message includes a resume identifier (ID) associated with the UE and an authentication token associated with the UE; and
receiving, after transmitting the RRC message and the user data in the SDT, an RRC release message terminating the SDT.

10. The method of claim 1, wherein transmitting the user data in the SDT comprises transmitting the user data in the SDT together with an identifier of the UE and security information associated with the UE.

11. The method of claim 1, further comprising transmitting, to the NTBS while the UE is in the idle or inactive mode, at least one of:
a buffer status report (BSR), indicating a buffer status of the UE associated with newly-arrived user data for transmission via a data radio bearer (DRB) associated with the SDT or other DRBs; or
a power headroom report (PHR), indicating a remaining power level of the UE for uplink transmissions.

12. The method of claim 1, wherein resources for performing a random access channel (RACH) procedure for initiating the SDT are distinct from resources for performing a RACH procedure for non-SDT communication.

13. The method of claim 12, wherein the resources for performing the RACH procedure for initiating the SDT include at least one of:
random access occasions (ROs) that are distinct from ROs for non-SDT communication; or
RACH preambles, including the dedicated RACH preamble, that are distinct from RACH preambles for non-SDT communication.

14. A method for wireless communication by a user equipment (UE), comprising:
receiving, from a first non-terrestrial base station (NTBS) in a non-terrestrial network (NTN), a first message including:
a first indication of a set of resources for communicating user data in a small data transfer (SDT) while the UE is in an idle or inactive mode; and
a second indication of a dedicated random access channel (RACH) preamble for initiating the SDT; and
communicating the user data in the SDT while the UE is in the idle or inactive mode via the set of resources indicated in the first message.

15. The method of claim 14, wherein receiving the first message comprises receiving the first message while the UE is in a connected mode and the first message comprises a radio resource control (RRC) release message.

16. The method of claim 15, further comprising transmitting, to the first NTBS while the UE is in the connected mode, an SDT indication message, requesting the dedicated RACH preamble and the set of resources for communicating the user data in the SDT.

17. The method of claim 16, wherein communicating the user data in the SDT comprises transmitting the user data in the SDT to the first NTBS.

18. The method of claim 14, wherein receiving the first message comprises receiving the first message in a paging message from the first NTBS.

19. The method of claim 18, wherein:
the first message further includes a mobile terminating (MT)-SDT indication, indicating that the user data comprises MT data, and
communicating the user data in the SDT comprises receiving, based on the MT-SDT indication, the MT data in the SDT from the first NTBS.

20. The method of claim 14, further comprising performing a RACH procedure with the NTBS for initiating the SDT, wherein performing the RACH procedure comprises:
transmitting, to the first NTBS, the dedicated RACH preamble to initiate the SDT; and
receiving, based on the dedicated RACH preamble, a RACH response message indicating a time advance (TA) for communicating the user data in the SDT, wherein communicating the SDT comprises communicating the user data in the SDT with the first NTBS based on the TA received in the RACH response message.

21. The method of claim 20, wherein resources for performing the RACH procedure for initiating the SDT are distinct from resources for performing a RACH procedure for non-SDT communication.

22. The method of claim 21, wherein the resources for performing the RACH procedure for initiating the SDT include at least one of:
random access occasions (ROs) that are distinct from ROs for non-SDT communication; or
RACH preambles, including the dedicated RACH preamble, that are distinct from RACH preambles for non-SDT communication.

23. The method of claim 14, wherein:
the first message comprises a radio resource control (RRC) reconfiguration message, instructing the UE to handover to a second NTBS from the first NTBS, and
the set of resources for communicating the user data in the SDT and the dedicated RACH preamble are associated with the second NTBS; and
communicating the user data in the SDT comprises communicating the user data in the SDT with the second NTBS after handing over to the second NTBS.

24. An apparatus for wireless communication, comprising:
a memory comprising executable instructions; and
one or more processors configured to execute the executable instructions and cause the apparatus to:
transmit, to a non-terrestrial base station (NTBS) in a non-terrestrial network (NTN), a small data transfer (SDT) indication message including a first indication that the apparatus has user data to transmit in an SDT while the apparatus is in an idle or inactive mode;
receive, from the NTBS in response to the SDT indication message, a resource indication message including an indication of a set of resources for transmitting the user data while the apparatus is in the idle or inactive mode; and
transmit the user data in the SDT to the NTBS while the apparatus is in the idle or inactive mode via the set of resources indicated in the resource indication message.

25. The apparatus of claim 24, wherein:
the one or more processors are further configured to cause the apparatus to:
select a four-step random access channel (RACH) procedure to transmit the SDT indication message;
transmit, to the NTBS, a RACH preamble in a first message of the four-step RACH procedure;
receive, from the NTBS in response to the RACH preamble, a second message of the four-step RACH procedure indicating the TA for the apparatus to use for communicating with the NTBS;
transmit, to the NTBS in response to receiving the second message of the four-step RACH procedure, a third message of the four-step RACH procedure, wherein the third message of the four-step RACH procedure comprises the SDT indication message,
receive, in response to the SDT indication in the third message of the four-step RACH procedure, a fourth message of the four-step RACH procedure, wherein the fourth message of the four-step RACH procedure comprises the resource indication message.

26. The apparatus of claim 24, wherein the one or more processors are configured to cause the apparatus to:
select a two-step random access channel (RACH) procedure to transmit the SDT indication message;
transmit, to the NTBS, a first message of the two-step RACH procedure, wherein the first message of the two-step RACH procedure includes a RACH preamble portion and a physical uplink shared channel (PUSCH) payload portion, and wherein the PUSCH payload portion of the first message of the two-step RACH procedure comprises the SDT indication message; and
receive, from the NTBS in response to the first message of the two-step RACH procedure, a second message of the two-step RACH procedure, wherein the second message of the two-step RACH procedure comprises the resource indication message.

27. An apparatus for wireless communication, comprising:
a memory comprising executable instructions; and
one or more processors configured to execute the executable instructions and cause the apparatus to:
receive, from a first non-terrestrial base station (NTBS) in a non-terrestrial network (NTN), a first message including:
a first indication of a set of resources for communicating user data in a small data transfer (SDT) while the apparatus is in an idle or inactive mode; and
a second indication of a dedicated random access channel (RACH) preamble for initiating the SDT; and
communicate the user data in the SDT while the apparatus is in the idle or inactive mode via the set of resources indicated in the first message.

28. The apparatus of claim 27, wherein:
the one or more processors are further configured to cause the apparatus to transmit, to the first NTBS while the apparatus is in a connected mode, an SDT indication message, requesting the dedicated RACH preamble and the set of resources for communicating the user data in the SDT,
the one or more processors are further configured to cause the apparatus to receive the first message while the apparatus is in the connected mode,
the first message comprises a radio resource control (RRC) release message, and
in order to communicate the user data in the SDT, the one or more processors are further configured to cause the apparatus to transmit the user data in the SDT to the first NTBS.

29. The apparatus of claim 27, wherein:
the one or more processors are further configured to cause the apparatus to receive the first message in a paging message from the first NTBS,
the first message further includes a mobile terminating (MT)-SDT indication, indicating that the user data comprises MT data, and
in order to communicate the user data in the SDT, the one or more processors are further configured to cause the apparatus to receive, based on the MT-SDT indication, the MT data in the SDT from the first NTBS.

30. The apparatus of claim 27, wherein:
the one or more processors are further configured to cause the apparatus to perform a RACH procedure with the first NTBS for initiating the SDT,
in order to perform the RACH procedure with the first NTBS, the one or more processors are further configured to cause the apparatus to:
transmit, to the first NTBS, the dedicated RACH preamble to initiate the SDT; and
receive, based on the dedicated RACH preamble, a RACH response message indicating a time advance (TA) for communicating the user data in the SDT; and
in order to communicate the user data in the SDT, the one or more processors are further configured to cause the apparatus to communicate the user data in the SDT with the first NTBS based on the TA received in the RACH response message.
